(19) United States
(12) Patent Application Publication
(10) Pub. No.: US 2012/0216490 A1
(43) Pub. Date: Aug. 30, 2012

(54) METHODS AND APPARATUS FOR HANDLING STACKABLE ARTICLES

(76) Inventors: Clay C. COOPER, Clifton Park, NY (US); Thomas MARCELLA, Mechanicville, NY (US); Scott A. WHEELER, Queensbury, NY (US)

(21) Appl. No.: 13/405,470

(22) Filed: Feb. 27, 2012

Related U.S. Application Data
(60) Provisional application No. 61/447,506, filed on Feb. 28, 2011.

(51) Int. Cl. B65B 35/50; B65B 35/30; B65B 35/24; B25J 15/00

(52) U.S. Cl. 53/447; 294/81.51; 53/532

(57) ABSTRACT

The system and apparatus for processing stackable articles transported in a set number of columns and rows on a conveyor is disclosed. The apparatus includes a receiver positioned to receive the articles discharged from the conveyor to form stacks of articles in the set number of columns. The stacks have a set number of articles per stack. A transfer device is positioned with respect to the receiver to transfer the stacks of articles while being able to continue to transport additional rows of stackable articles on the conveyor to form multiple columns and rows of stacks of articles within the transfer device.

### CLAIM OF PRIORITY

This application claims priority to U.S. Provisional Application No. 61/447,506 filed Feb. 28, 2011, entitled “Methods and Apparatus for Handling Stackable Articles”, the entire contents of which are incorporated herein by reference.

### BACKGROUND OF THE INVENTION

1. Field of the Invention

The present invention relates, generally, methods and apparatus for handling articles, for example, stackable articles, such as, stackable food items. In particular, methods and apparatus are disclosed for handling stackable food items, such as, frozen hamburger patties, for efficient handling and packaging.

2. Description of Related Art

Many methods and apparatus have been provided in the art for efficiently handling food articles, for example, frozen hamburger patties. Some methods and apparatus are disclosed in the following U.S. Pat. Nos. 3,927,508; 3,959,951; 4,648,237; 4,789,055; 4,827,692; 5,069,019; 5,165,218; 5,480,278; and 5,551,550.

However, these prior art methods and apparatus have deficiencies that indicate that a need exists for improving the handling of stackable articles in general, and stackable food items in particular. For example, deficiencies may include the inability of the systems to process and stack articles in a container without stopping a conveyor whereby such articles are supplied for stacking. As described in detail below, aspects of the present invention overcome some of the deficiencies of these and other prior art and provide the desired improved methods and apparatus.

### SUMMARY OF ASPECTS OF THE INVENTION

In one aspect, the invention includes a method of processing stackable articles transported in rows on a conveyor where articles oriented on the conveyor in a set number of columns. The method includes discharging the articles from the conveyor into a receiver to form stacks of stackable articles in the set number of columns; the stacks have a set number of articles per stack. The method also includes transferring the set number of columns of stacks of articles into a transfer device while being able to continue to transport additional rows of stackable articles on the conveyor. The discharging and transferring steps are repeated while being able to continue to transport additional rows of stackable materials on the conveyor, to form multiple columns and rows of stacks of articles within the transfer device. The method also includes operating the transfer device to transport the multiple rows and columns of the stacks of articles within the transfer device and discharging the multiple rows and stacks of articles into a container.

The method may be performed so that the transferring step includes moving the set number of columns of stacks of said articles from a first position to a staging area so that the set number of columns of stacks of articles are inserted into the transfer device from the staging area.

The method may be performed so that the transferring step includes moving the set number of columns of stacks.

The columns of stacks of said articles may be moved from the first position to the staging area by translating the stacks of articles from the first position to the staging area. The staging area may be located in alignment with the transfer device when the columns of stack of said articles are transferred into the transfer device.

The columns of stacks of articles may be vertically inserted into receiving columns of the transfer device. Also, the columns of stacks of articles may be moved from the first position to a transfer position, and from the transfer position to the staging area. Also, the columns of stacks of articles may be vertically inserted into the receiving columns of the transfer devices by moving less than the set number of columns of stacks of articles from the staging area in a first step and vertically inserting the remainder of the columns of stacks of articles from the staging area in one or more subsequent steps.

The transfer device receives an array of stacks of articles where the number of columns in the array is less than the set number of columns, as well as a set number of rows of stack of articles. The array of stacks is sized to fit into the container. The transfer device is moveable in a horizontal plane in two dimensions whereby the receiving columns are positioned in vertical alignment with the stacks of articles in the staging area. The transfer device is moveable to receive less than the set number of columns of stacks from the staging area in a first step within a first row of the transfer device. And, the transfer device is moveable to receive the remainder of columns of stacks of articles in one or more subsequent steps from the staging area in at least a second row of the transfer device.

The container is positioned on a platform, which is vertically moveable towards the transfer device to place the container proximate the transfer device so that the transfer device releases the multiple rows of stacks of articles into the container by vertically discharging them into the container.

In another aspect, the invention includes an apparatus for processing stackable articles transported in rows on a conveyor where the articles are oriented in a set number of columns. The apparatus includes a receiver positioned to receive articles discharged from the conveyor to form stacks of the stackable articles in the set number of columns.

A transfer device is positionable with respect to the receiver to transfer the set number of columns of stacks of the articles while being able to continue to transport additional rows of stackable articles on the conveyor to form multiple columns and rows of stacks of articles within the transfer device. The transfer device is operable to transport the multiple rows and columns of stacks of articles therein. A container support is positionable to support a container proximate the transfer device so that the transfer device discharges the multiple rows and stacks of articles into the container.

The receiver includes a staging area positioned to allow the set number of columns of stacks of articles received from a first position to be inserted into the transfer device from the staging area. The staging is located in alignment with the transfer device when the set number of columns of the stacks of articles are transferred into the transfer device. The transfer device comprises an array of receiving columns positionable to receive the set number of columns of stacks of articles vertically inserted into the receiving columns.

The receiver moves the set number of columns of stacks of articles from the first position to a transfer position, and from the transfer position to the staging area. The transfer device is moveable to receive said less than the set number of columns of stacks of articles from the staging area in a first step and the remainder of the columns of stacks of articles from the staging area in one or more subsequent steps.

The transfer device is configured to receive an array of stacks of articles. The array including a number of columns less than the set number of columns, as well as a set number of columns and a set number of rows of stack of articles. The array of stacks fits into the container.

The transfer device is moveable in a horizontal plane in two dimensions to position the receiving columns in vertical alignment with said stacks of articles in said staging area.

The transfer device is moveable to receive said less than the set number of columns of said stacks from the staging area in a first step within a first row of the transfer device. And, the transfer device is moveable to receive the remainder of the set number of columns of stacks of articles in one or more subsequent steps from the staging area in at least a second row of the transfer device.

The container support is vertically moveable towards the transfer device to place the container proximate the transfer device so that the transfer device releases the multiple rows of stacks of articles into the container and the stacks of articles are vertically discharged from the transfer device into the container.

Another aspect of the present invention is a method for handling articles, for example, stackable articles, comprising or including the steps of a) transferring a plurality of the articles in N columns on a conveyor, wherein N is an integer greater than zero; b) discharging the N columns of the articles from the conveyor to a receiver and forming N stacks of the articles, each of the N stacks of the articles having M articles per stack, wherein M is an integer greater than zero; c) transferring J stacks of the articles of the N stacks of the articles having M articles per stack from the receiver to a transfer device, wherein J comprises an integer greater than zero and less than or equal to N; d) repeating step c) at least once to accumulate K rows of J stacks of the articles having M articles per stack on the transfer device, where K is an integer greater than zero; and e) transferring the K rows of J stacks of the articles to a container with the transfer device. In one aspect, the step c) transferring J stacks of the N stacks of the articles may be practiced by steps c1) transferring the J stacks of articles from a first position in the receiver to a second position; and c2) transferring the J stacks of articles from the second position to the transfer device. In another aspect, the step c2) transferring the J stacks of articles from the second position to the transfer device may be practiced by positioning the transfer device over the J stacks of articles, and transferring the J stacks from the second position to the transfer device.

In one aspect, the step c2) transferring the J stacks of articles from the second position to the transfer device may be practiced by transferring the J stacks to a third position, for example, a “staging position,” displaced from the second position, and transferring the J stacks from the third position to the transfer device.

Another embodiment of the invention is an apparatus for handling articles, for example, stackable articles, comprising or including: a first conveyor adapted to transfer and discharge a plurality of the articles in N columns of articles, wherein N is an integer greater than zero; a receiver positioned to receive the N columns of articles discharged from the first conveyor and to form N stacks of the articles, each of the N stacks of the articles having M articles per stack, wherein M is an integer greater than zero; a second conveyor adapted to transfer J stacks of the N stacks of the articles from the receiver, wherein J comprises an integer greater than zero and less than or equal to N; and a transfer device adapted to receive K rows of the J stacks of articles from the second conveyor and transfer the K rows of J stacks of the articles to a container, wherein K is an integer greater than zero. In one aspect, the receiver comprises a first position and a second position, and a transfer device adapted to transfer the J stacks of the N stacks of the articles from the first position to the second position, wherein the second position is accessible by the second conveyor. In another aspect, the apparatus further comprises a staging position adapted to receive the J stacks of articles from the second position and wherein the staging position is accessible by the second conveyor.

In some aspects of the invention, the value K may be an odd integer. In another aspect, the value N may be an even integer. For example, in one aspect, N equals 6, J equals 3, and K equals 5. In one aspect, the articles may be stackable, disc-like articles, for example, stackable, disc-like food items, such as, frozen hamburger patties.

A further embodiment of the invention is an article retaining device comprising or including a transfer guide; one or more rods mounted for translation within the transfer guide, the rod having a first end operatively connected to a source of motion and a second end opposite the first end; one or more guide sleeves adapted to translate within the transfer guide, the one or more guide sleeves having a first end mounted to the second end of one or the one or more rods and a second end opposite the first end; and a lever arm having a first end pivotally mounted to the second end of one of the one or more guide sleeves and a second end, the lever arm having a camming surface positioned and adapted to contact an obstruction in the transfer guide and urge the second end of the lever arm through an opening in the transfer guide wherein the second end projects from the transfer guide to provide a retaining surface. In one aspect, the transfer guide may be a channel, a tube, or a pipe. In another aspect, the lever arm may be a plurality of lever arms, for example, 2, 3, 4, or more. In one aspect, the guide sleeves may be cylindrical bodies shaped to conform to a plurality of surfaces of the transfer guide. In one aspect, the device may be adapted to retain stackable articles, such as, frozen hamburger patties.

Another embodiment of the invention is a stacked article retaining system comprising or including a plurality of retaining devices described; and a source of motion operatively connected to each of the rods of the plurality of retaining devices.

The invention is capable of facilitating fast production and handling of stackable articles supplied via a conveyor in such a manner where the articles may be placed in stacks within a container without stopping or slowing the conveyor while filling multiple successive containers. For example, a conveyor traveling at a high speed with six columns of stackable items per consecutive row, for example, frozen hamburger patties, may be operated to fill 900 patties per minute in containers and/or 2.4 cases of such patties per minute without slowing the conveyor during the process.

Details of these aspects of the invention, as well as further aspects of the invention, will become more readily apparent upon review of the following drawings and the accompanying claims.

### BRIEF DESCRIPTION OF THE FIGURES

The subject matter that is regarded as the invention is particularly pointed out and distinctly claimed in the claims at the conclusion of the specification. The foregoing and other features and advantages of the invention will be readily understood from the following detailed description of aspects of the invention taken in conjunction with the accompanying drawings in which:

FIG. 1 is a schematic illustration of one aspect of the invention illustrating a desired handling of articles.

FIGS. 2 through 5 are schematic illustrations, similar to FIG. 1, of aspects of the of the invention providing a handling of articles in order to achieve the desired handling illustrated in FIG. 1 according to one aspect of the invention.

FIG. 6 is a schematic illustration, similar to FIGS. 1 and 2, of a disadvantage of the handling of articles illustrated in FIGS. 1 through 5.

FIGS. 7 through 9 are schematic illustrations, similar to FIGS. 1-6, of a handling of articles to achieve the desired handling illustrated in FIG. 1 according to one aspect of the invention.

FIG. 10 is perspective view of a system embodying aspects of the invention.

FIG. 11 is a perspective view of the system shown in FIG. 10, with certain structures removed to facilitate illustration of aspects of the invention.

FIG. 12 a front elevation view of the system shown in FIG. 11.

FIG. 13 is a right side elevation view of the system shown in FIG. 11.

FIG. 14 is a rear elevation view of the system shown in FIG. 11.

FIG. 15 is a left side elevation view of the system shown in FIG. 11.

FIG. 16 is a top plan view of the system shown in FIG. 11.

FIG. 17 is a detailed perspective view of the conveyor shown in FIGS. 11 through 16.

FIG. 18 is a partial side elevation view of the conveyor shown in FIG. 17.

FIG. 19 is a perspective view of a receiver and shuttle mechanism shown in FIGS. 11 through 16.

FIG. 20 is a front elevation view of the receiver and shuttle mechanism shown in FIG. 19.

FIG. 21 is a top plan view of the receiver and shuttle mechanism shown in FIG. 19.

FIG. 22 is a perspective view of a shuttle conveyor shown in FIGS. 19 through 21.

FIG. 23 is a perspective view of a conveyor system that may be used to convey the transfer device shown in FIGS. 24 through 27.

FIG. 24 is a perspective view of a transfer device shown in FIGS. 11 through 16.

FIG. 25 is a front elevation view of the transfer device shown in FIG. 24, the rear elevation view being a mirror image thereof.

FIG. 26 is a right-side elevation view of the transfer device shown in FIG. 24, the left-side elevation view being a mirror image thereof.

FIG. 27 is a bottom view of the transfer device shown in FIGURE 24.

FIG. 28 schematic illustration, partially in cross section, of a retaining device according to another aspect of the invention.

FIG. 29 is a perspective view of one retaining device according to one aspect of the invention.

FIG. 30 is a front elevation view of the retaining device shown in FIG. 29, the rear elevation view being a mirror image thereof.

FIG. 31 is a right-side elevation view of the retaining device shown in FIG. 29, the left-side elevation view being a mirror image thereof.

FIG. 32 is a bottom view of the retaining device shown in FIG. 29.

FIG. 33 is an exploded perspective view of the retaining device shown in FIG. 29.

FIG. 34 is a perspective view of the guide sleeve shown in FIGURE 33.

FIG. 35 is a left-side elevation view of the guide sleeve shown in FIG. 34, the right-side elevation being a mirror image thereof.

FIG. 36 is a front elevation view of guide sleeve shown in FIG. 34

FIG. 37 is a rear elevation view of guide sleeve shown in FIG. 34.

FIG. 38 is a perspective view of the lever arm shown in FIG. 33.

FIG. 39 is a right-side elevation view of the lever arm shown in FIG. 38, the left-side elevation view being a mirror image thereof.

FIG. 40 is a perspective view of the container location shown in FIGS. 10-15.

FIG. 41 is a right-side elevation view of the container location shown in FIG. 40.

FIG. 42 is a schematic diagram of the transfer of stackable articles from the conveyor to the transfer device.

### DETAILED DESCRIPTION OF FIGURES

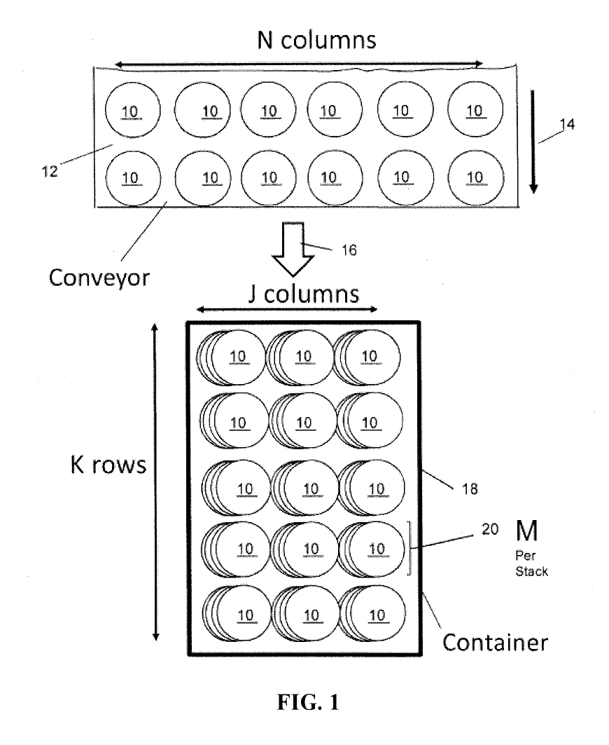

The details and scope of the aspects of the present invention can best be understood upon review of the attached figures and their following descriptions. FIG. 1 is a schematic illustration of one aspect of the invention illustrating a desired handling of articles 10. As shown in FIG. 1, according to one aspect, a plurality of N columns of articles 10, for example, a plurality of hamburgers, bagels, waffles, chicken breasts, compact disks, and the like, are provided on a conveyor 12 traveling in the direction of arrow 14. In one aspect, articles 10 are “stackable” articles, that is, the articles 10 can be laid one on top of the other to form a generally vertically column of articles 10. It is to be understood that, in some aspects, the number of articles 10 that may be stacked may be limited by the number in the stack; for example, frozen chicken breasts may have a limited capability to be “stacked” one on top of the other, but can still be handled by aspects of the invention.

According to aspects of the invention, the number N is an integer greater then zero, and may range from 2 to 10, or to 100, or to even 1000. However, N is typically less then 10, for example, from about 2 to about 8 columns, and N may be an odd or an even integer. Conveyor 12 may typically be a belt conveyor for example, a belt conveyor that transfers articles 10 at a rate of between about 5 articles per minute to about 20,000 articles per minute, for example, between about 800 articles per minute to about 1000 articles per minute.

According to aspects of the invention, articles 10 conveyed by conveyor 12 in rows N are transferred, as indicated by arrow 16, typically, continuously, for example, without interruption, to a container or carton 18, for instance, for further handling, for instance, for storage or shipping. Articles 10 are received by container 18 in J columns of K rows of stacks 20. Stacks 20 include M articles per stack. According to aspects of the invention, J, K, and M are integers greater than zero, and may be odd or even. For example, J may range from 1 to 100, but is typically ranges from 2 to 6, for instance, J may be 3; K may range from 1 to 100, but is typically ranges from 3 to 10, for instance, K may be 5; M may range from 1 to 100, but is typically ranges from 10 to 50, for instance, M may be 25.

Aspects of the invention provide methods and systems for transferring articles 10 in N columns transferred by conveyor 12 to container 18 in J columns, of K rows of stacks 20 having M articles per stack.

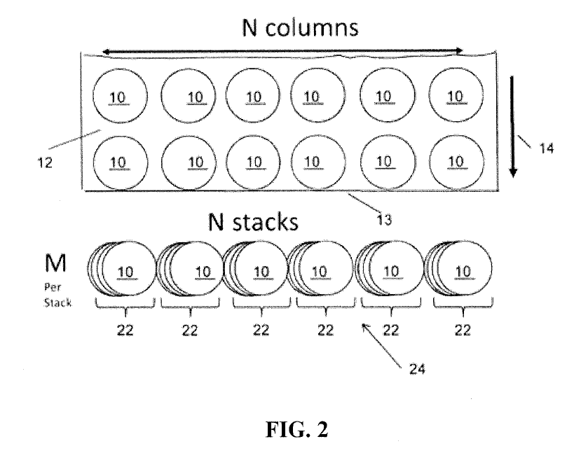

FIGS. 2 through 5 are schematic illustrations, similar to FIG. 1, of one aspect of the invention providing a handling of articles 10 in order to achieve the desired handling illustrated in FIG. 1. FIG. 2 illustrates the transfer of articles 10 in N columns from conveyor 12, for example, off the end 13 of conveyor 12 in the direction of arrow 14, to N stacks 22 (which may be the same as or similar to stacks 20 shown in FIG. 1), each stack 22 having M articles at a location 24. Stacks 22 may be positioned in location 24 anywhere where they are accessible for further handling, for example, location 24 may be a hopper, a tray, a shelf, a platform, a surface, or a retaining device, among other locations. Again, N may be an odd integer or an even integer and may range from 2 to 100, but typically N is less than 10; and M may be odd integer or even integer and may range from 1 to 100, but is typically ranges from 10 to 50, for instance, M may be 25.

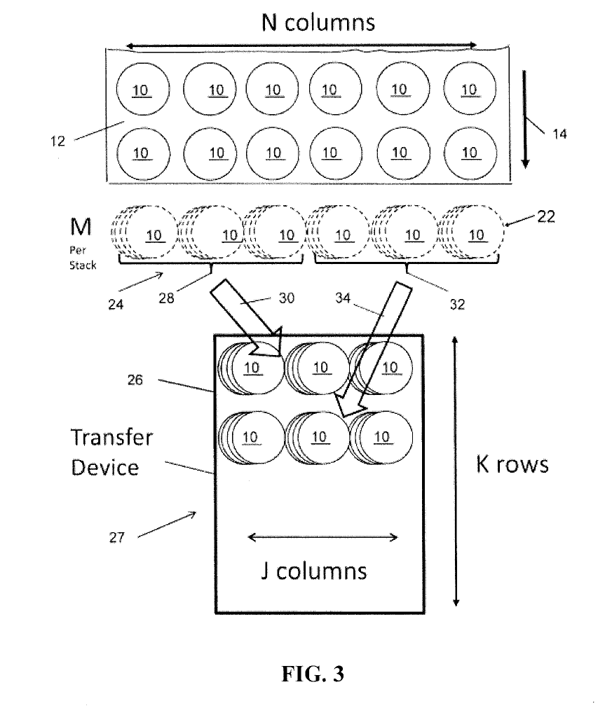

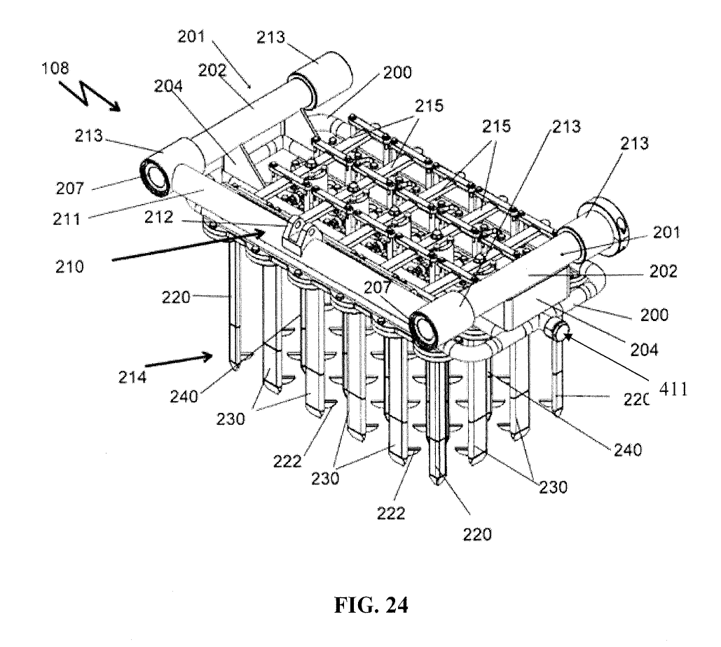

FIG. 3 is a schematic illustration of one aspect of the invention providing a transfer of stacks 22 of M articles 10 from location 24 to a transfer device 26. In one aspect, while stacks 22 are being transferred to transfer device 26, articles 10 may continue to be transferred from conveyor 12 to stacks 22 in location 24. According to aspects of the invention, transfer device 26 may be any transfer device adapted to receive J columns of K rows of stacks 22 of M articles 10 in a first location 27 and transfer the J columns of K rows of stacks 22 of M articles 10 from the first location 27 to a second, different location (not shown in FIG. 3), for example, to a location having the container 18 shown in FIG. 1. In one aspect, transfer device 26 may be the transfer device 108 shown and described with respect to FIGS. 24-27. J may be an odd or even integer greater than zero, and may be less than or equal to N, that is, the number of stacks of M articles positioned at location N in FIG. 2. In one aspect, J may be one half the valve of N, for example, when N is 6, J may be 3.

As shown in FIG. 3, in one aspect, the transfer of articles 10 from location 24 to transfer device 26 may be practiced piecemeal, that is, only some of the stacks 22 of M articles 10 may be transferred at a time. For example, in one aspect, J stacks 28 of M articles 10 may first be transferred from location 24 to transfer device 26 as indicated by arrow 30. Subsequently, J stacks 32 of M articles 10 may then be transferred from location 24 to transfer device 26 as indicated by arrow 34. As shown in FIG. 3, after transfer of stacks 22 of articles 10 from location 24, stacks 22 and articles 10 are illustrated in phantom indicating that the stacks 22 and articles 10 are no longer in location 24. Again, as noted above, during the transfer indicated by arrows 30 and 32, articles 10 may continue to be transferred from conveyor 12 to location 24, as indicated by the non-phantom articles 10 shown in conveyor 12 in FIG. 3.

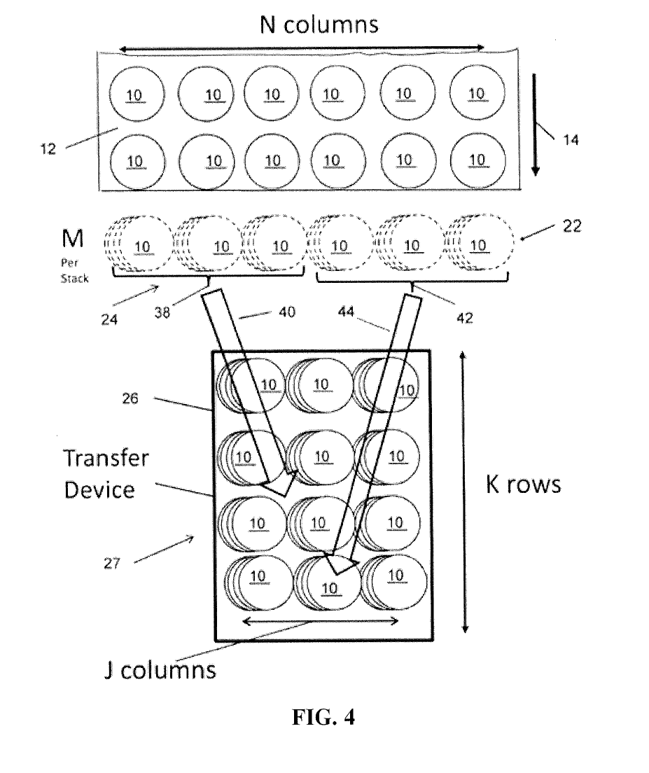

FIG. 4 is a schematic illustration, similar to FIG. 3, of one aspect of the of the invention illustrating a subsequent transfer of stacks 22 of M articles 10 from location 24 to a transfer device 26 according to an aspect of the invention. As shown in FIG. 4, the transfer of articles 10 from location 24 to transfer device 26 may be practiced piecemeal. For example, in one aspect, J stacks 38 of M articles 10, which may have replaced stacks 28 in location 24, may be transferred from location 24 to transfer device 26 as indicated by arrow 40. Subsequently, J stacks 42 of M articles 10, which may have replaced stacks 32 in location 24, may then be transferred from location 24 to transfer device 26 as indicated by arrow 44. As shown in FIG. 4, after transfer of stacks 22 of articles 10 from location 24, stacks 22 and articles 10 are illustrated in phantom indicating that the stacks 22 and articles 10 are no longer in location 24. Again, as noted above, during the transfer indicated by arrows 40 and 42, articles 10 may continue to transfer from conveyor 12 to location 24, as indicated by the non-phantom articles 10 shown in conveyor 12 in FIG. 4.

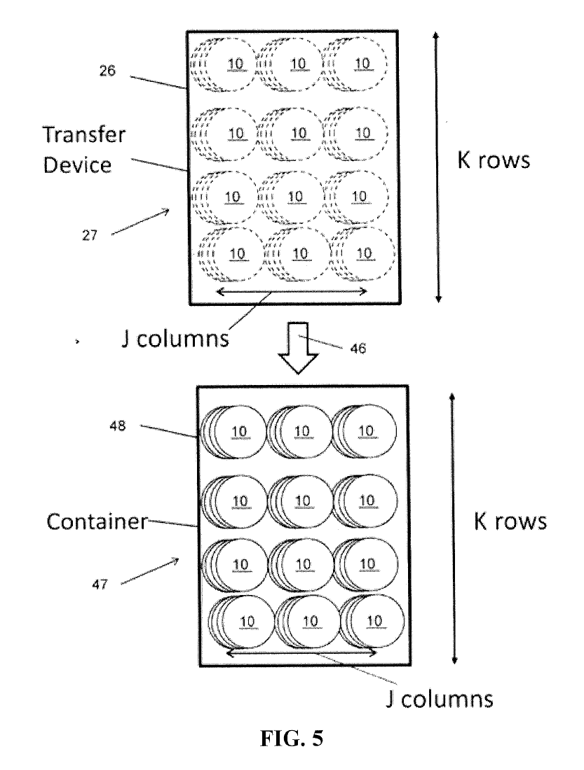

FIG. 5 is a schematic illustration, similar to FIGS. 2-4, of one aspect of the of the invention illustrating a subsequent transfer of stacks 22 of M articles 10 from first location 27 to a second location 47 using transfer device 26 as indicated by arrow 46. Again, in FIG. 5, after transfer of the stacks 20 from transfer device 26, stacks 20 of articles 10 are shown in phantom in FIG. 5. In the aspect shown in FIG. 5, location 47 includes a container 48, for example, a box, a crate, bin, or any other receptacle adapted to receive J columns and K rows of stacks 22 having M articles 10. Location 47 may be a hopper, a tray, a shelf, a platform, a surface, or a retaining device, among other locations. According to aspects of the invention, transfer device 26 is adapted to receive and transfer stacks 22 from first location 27 to second location 47 and deposit or discharge stacks 22 in location 47, for example, in a box 48.

As illustrated in FIGS. 2 through 5, aspects of the invention provide methods and systems for transferring articles 10 introduced in N columns transferred by conveyor 12 (FIG. 2) to container 48 (FIG. 5) in J columns, of K rows of stacks 22 having M articles per stack. For example, in one aspect, methods and systems for transferring articles 10 introduced in 6 columns transferred by conveyor 12 to container 48 in 3 columns, of 5 rows of stacks 22 having 25 articles per stack.

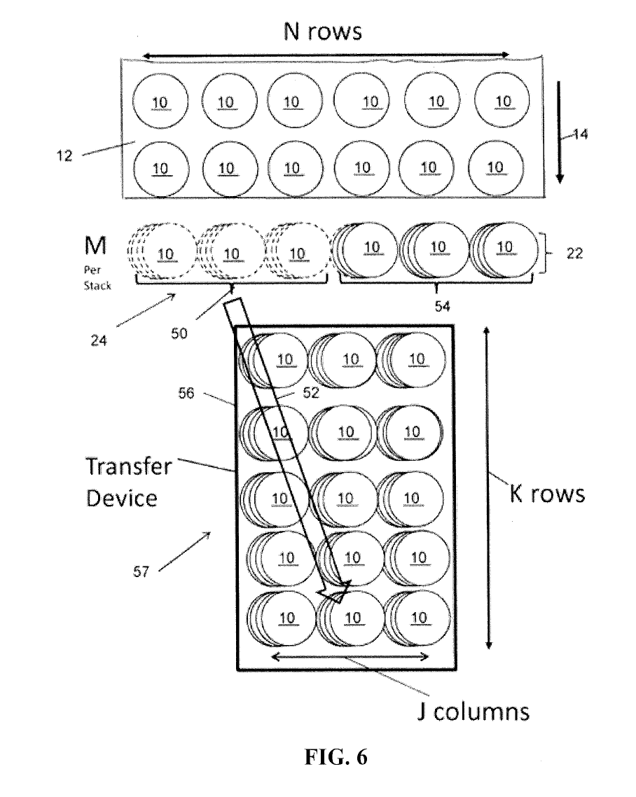

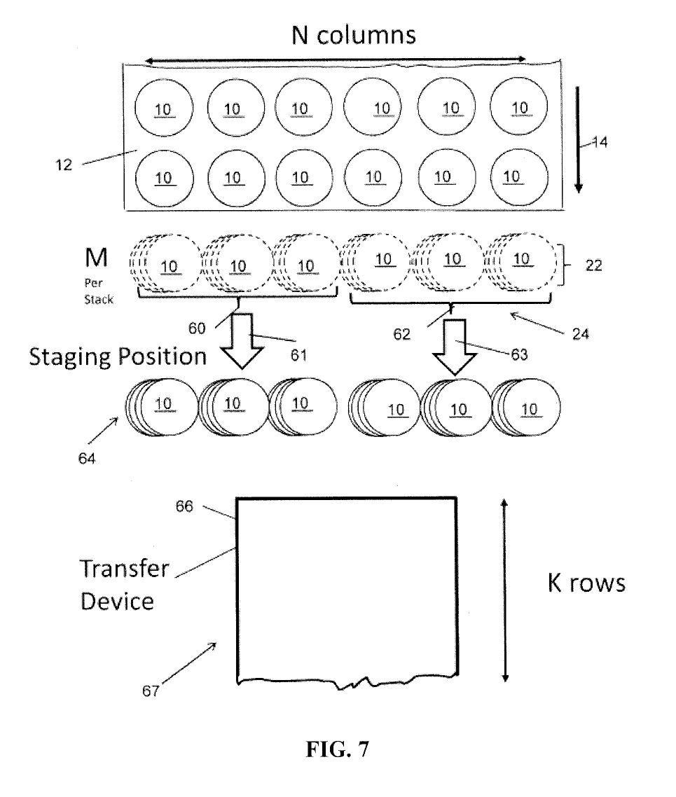

FIG. 6 is a schematic illustration, similar to FIGS. 1 and 2, of a disadvantage of the handling of articles illustrated in FIGS. 2 through 5 that can be addressed by the aspects of the invention illustrated and described with respect to FIGS. 7 through 9. However, before proceeding with a description of the aspect of the invention shown in FIGS. 7-9, a description of a disadvantage of the aspect shown in FIGS. 2-5 is provided.

Returning for the moment to FIGS. 4 and 5, in one aspect, the transfer of stacks 22 from location 24 as indicated by arrows 30, 34, 40, and 44 may be sufficient to provide the desired number of rows K of columns J of stacks 22 of articles 10, for example, the container 48 may be sufficiently filled to provide the desired stacks 22 of M articles in container 48 (FIG. 5). Specifically, in one aspect, the quotient resulting from the division of the number of columns N provided on conveyor 12 by the number of columns J can be an even number and number of rows K of stacks 22 can be an even integer. Under these conditions, when transfer device 26 receives the desired number of stacks 22, no stacks 22 are left in position 24 (for example, as shown in FIG. 4). This can be expressed as Equations 1 and 2.

N/J=R, Equation 1

where R is an even integer greater than or equal to 2, and

K is an even integer Equation 2.

For example, when N is 6, J may be 3 (that is, the quotient of N divided by J is an even integer, 2), and the number of rows K of stacks 22 is an even integer, for example, 4 (as shown in FIG. 4), the transfer of stacks as indicated by arrows 40 and 44 (FIG. 4) may satisfy the desired number of stacks 22 needed to be transferred by transfer device 26 to a second location, for example, to a container 48. Accordingly, when the number of stacks desired in transfer device 26 is satisfied, as shown in FIG. 4, no additional stacks 22 remain in location 24.

FIG. 6 is a schematic illustration, similar to FIGS. 1 through 5, of a disadvantage of the handling of stacks 22 of articles 10 illustrated in FIGS. 1 through 5. In the aspect of the invention, FIG. 6 illustrates conveyor 12 having articles 10 transferred to N stacks 22 having M articles 10 per stack in location 24. This aspect is substantially same as the aspect of the invention shown in FIGS. 1-5. However, as shown in FIG. 6, a transfer device 56 positioned in first position 57 is adapted to receive rows K and columns J of stacks M where K is an odd integer, for example, 5. According to this aspect of the invention, after transfer of stacks 22 to transfer device 56, for example, as indicated by the arrows 30, 34, 40, and 44 (FIGS. 4 and 5), four of the five rows K in transfer device 56 are filled. In the aspect of the invention shown in FIG. 6, the transfer of the 5^{th} row 50 of stacks 20, as indicate by arrow 52, substantially completely fills transfer device 56, but leaves an additional set of stacks 54 in location 24. In other words, though the transfer device 56 is completely filled for this aspect, and can transfer stacks 22 to the second location (not shown), some modification to the operation of the system shown must be made to account for the lone set 54 of stacks 22. Recall that, typically, even though sets 54 may remain in location 24, according to aspects of the invention, conveyor 12 continues to discharge articles 10 to stacks 22 in location 24.

In one aspect of the invention, the disadvantage of one aspect of the invention illustrated and described with respect to FIG. 6, may be overcome by adjusting the timing of the operation of aspects of the invention. For example, the rate of feed of conveyor 12 can be decreased to allow transfer device 56 to discharge stacks 22 to the second position and return to retrieve the set of stacks 54 before location 54 receives articles 10. However, though this may be done in one aspect of the invention, the increased in elapsed time required is undesirable. In another aspect, the disadvantage illustrated in FIG. 6 can be overcome by introducing multiple rows of stacks of articles 10 at location 24, such that two or more rows of stacks of articles 10 are accumulated at location 24 as articles 10 are discharged from conveyor 12. However, the introduction of multiple rows of stacks of articles 10 at location 24 would require at least two additional controlled movements: one to stack additional rows at location 24 as these articles 10 are discharged from conveyor 12 and one to transport this additional row or rows to transfer device 56. Though such a method and apparatus comprise aspects of the present invention, such a method and apparatus would be undesirable since it is expected that they would greatly increase the complexity and cost of the apparatus and of the associated control system.

However, as shown with respect to FIGS. 7 through 9, when at least one excess set of stacks 54 is encountered, the timing of the operation of aspects of the invention shown in FIGS. 2-6 may negatively affect the desire to minimize the elapsed time required to practice aspects of the invention.

FIGS. 7 through 9 are schematic illustrations, similar to FIGS. 1-6, of the handling of articles 10 to achieve the desired handling illustrated in FIG. 1 according to one aspect of the invention that overcomes the disadvantage shown in FIG. 6. In this aspect of the invention, FIG. 7 illustrates conveyor 12 having articles 10 transferred to N stacks 22 having M articles 10 per stack in location 24. This aspect is substantially same as the aspect of the invention shown in FIGS. 1-5. However, as shown in FIG. 7, in addition to the location 24, the system shown in FIG. 7 includes a second location 64 displaced from location 24. This second location 64, or “staging position” or “buffer position,” provides one means for overcoming the disadvantage of the aspect of the invention shown in FIG. 6.

According to this aspect of the invention, after stacks 22 are assembled in location 24, for example, sets 60 and 62 of stacks 22, stacks 22 may be transferred to staging position 64. As shown in FIG. 7, for example, set 60 may be transferred from location 24 to location 64 as indicated by arrow 61, and set 62 may be transferred from location 24 to location 64 as indicated by arrow 62. According to this aspect, a transfer device 66 may be adapted to receive stacks 22 positioned in staging position 64 instead, or in addition to, location 24, and transfer device 66 may transfer stacks 22 from position 67 to a second position (not shown), for example, to a container as described previously.

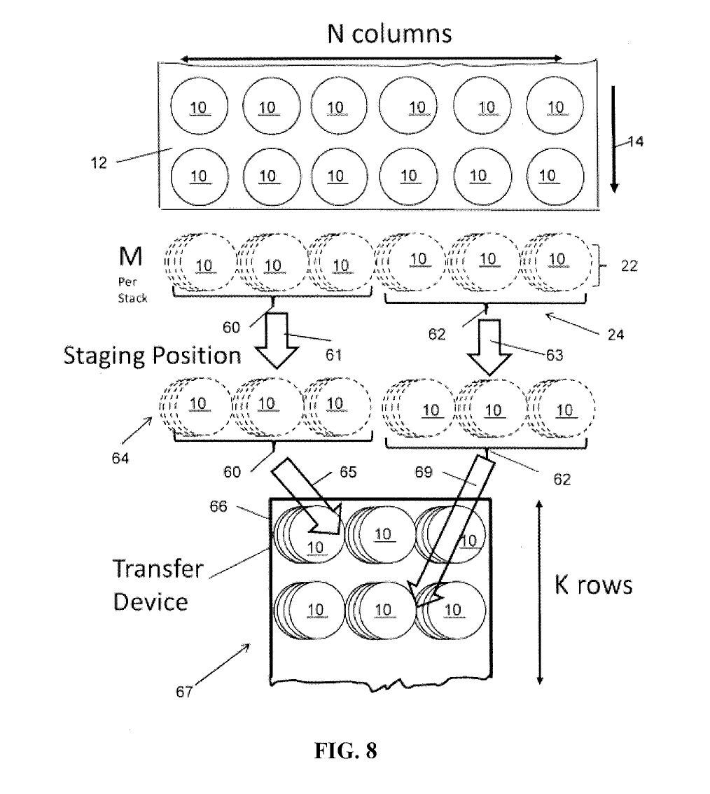

FIG. 8 is a schematic illustration of one aspect of the of the invention providing a transfer of stacks 22 of M articles 10 from staging position 64 to a transfer device 66 according to one aspect of the invention. Again, in one aspect, while stacks 22 are being transfer to transfer device 66, articles 10 may continue to be transferred from conveyor 12 to stacks 22 in location 24 and then to staging position 64. According to aspects of the invention, transfer device 66 may be any transfer device adapted to receive J columns of K rows of stacks 22 of M articles 10 in a first location 67 and transfer the J columns of K rows of stacks 22 of M articles 10 from the first location 67 to a second, different location, for example, to a location having a container.

As shown in FIG. 8, the transfer of stacks 22 of articles 10 from location 64 to transfer device 66 may be practiced piecemeal, that is, only some of the stacks 22 of M articles 10 may be transferred at a time. For example, in one aspect, J stacks 60 of M articles 10 may first be transferred from staging position 64 to transfer device 66 as indicated by arrow 65. Subsequently, J stacks 62 of M articles 10 may then be transferred from staging location 64 to transfer device 66 as indicated by arrow 69. As shown in FIG. 8, after transfer of stacks 22 of articles 10 from location 64, stacks 22 and articles 10 are illustrated in phantom indicating that the stacks 22 and articles 10 are no longer in staging location 64. Again, as noted above, during the transfer indicated by arrows 65 and 69, articles 10 may continue to transfer from conveyor 12 to location 24, as indicated by the non-phantom articles 10 shown in conveyor 12 in FIG. 8.

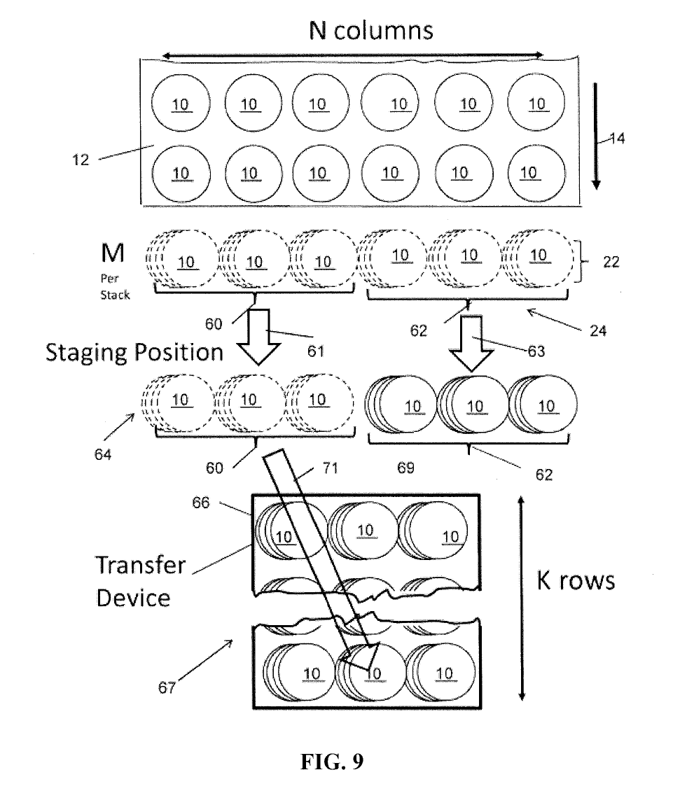

FIG. 9 is a schematic illustration, similar to FIGS. 7 and 8, of subsequent handing of stacks 22 of articles 10 illustrated in FIGS. 7 and 8. In the aspect of the invention, FIG. 8 illustrates conveyor 12 having articles 10 transferred to N stacks 22 having M articles 10 per stack in location 24 and then to staging position 64. This aspect is substantially same as the aspect of the invention shown in FIGS. 7 and 8. However, as shown in FIG. 9, a transfer device 66 positioned in first position 67 is adapted to receive rows K and columns J of stacks M where K may be an odd integer, for example, 5, or 7. According to this aspect of the invention, after transfer of stacks 22 to transfer device 66, for example, as indicated by the arrows 65 and 69 in FIG. 7, all but one of the odd number rows K in transfer device 66 are filled. In the aspect of the invention shown in FIG. 9, the transfer of the last row, for example, the 5^{th} or 7^{th} row, of stacks 20, as indicate by arrow 71, substantially completely fills transfer device 66, but leaves an additional set of stacks 62 (shown with solid, non-phantom lines) in staging position 64. As discussed above, with respect to FIG. 6, though the transfer device 66 may be completely filled for this aspect, and can transfer to stacks to the second location (not shown), unlike the aspects of the invention shown in FIG. 6, the system shown in FIG. 9, with staging position 64 distinct from location 24, can avoid the modification to the operation of the system due to the presence of the lone set 62 of stacks 22 in staging position 64. Unlike earlier aspects of the invention, since the positioning of articles 10 in stacks 22 in location 24 is not hindered by the presence of stacks 62 in staging position 64, transfer device 66 can receive stacks 62 from staging position 64 without requiring undesirable modification, in particular, reduced through put time, that may characterize other aspects of the invention.

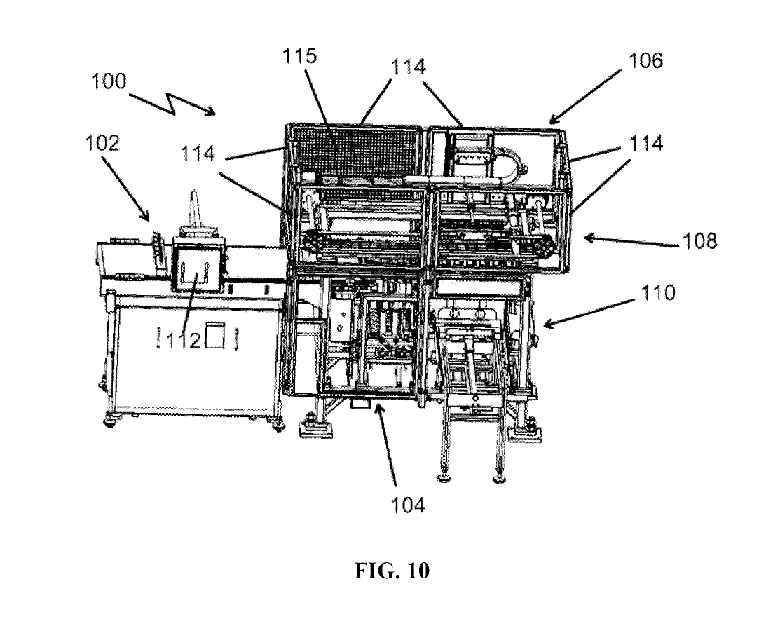

FIGS. 10-16 illustrate one system that may be used to implement the methods and apparatus illustrated in FIGS. 1-9.

FIG. 10 is perspective view of a system 100 embodying aspects of the invention. As shown in FIG. 10, system 100 includes a conveyor 102, for example, a belt conveyor, upon which articles 10 can be introduced to system 100, for example, from a hopper or feed system not shown in FIG. 10. Conveyor 102 may correspond to conveyor 12 shown in FIGS. 1 through 9. System 100 also includes a receiver and shuttle mechanism 104 adapted to receive articles 10 from conveyor 102 and transfer the articles for subsequent handling; a conveyor system 106 having a transfer device 108 adapted to receive articles 10 from the receiver and shuttle mechanism 104 and transfer the articles 10; and an container location 110 positioned to receive the articles 10 transferred by the conveyor system 106 and transfer device 108. Container location 110 may typically include a container (not shown) for receiving the transferred articles, for example, a box, or carton. As shown in FIG. 10, system 100 may include a control panel or user interface 112, with appropriate control and diagnostic hardware and software; and appropriate support structure 114, for example, commercial tubing and fasteners, and protective barriers or screens 115.

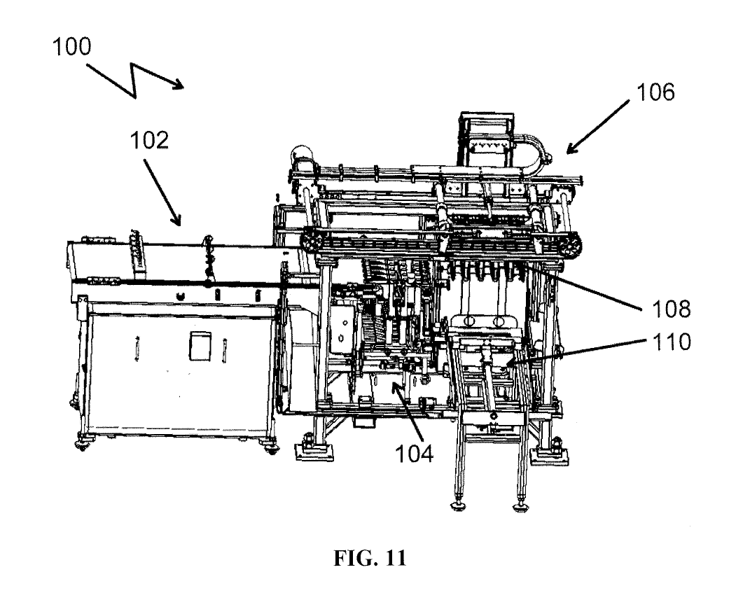

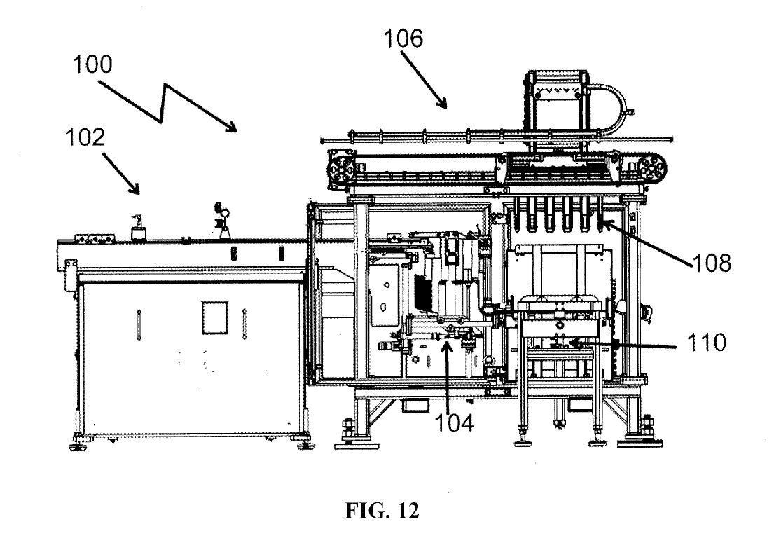

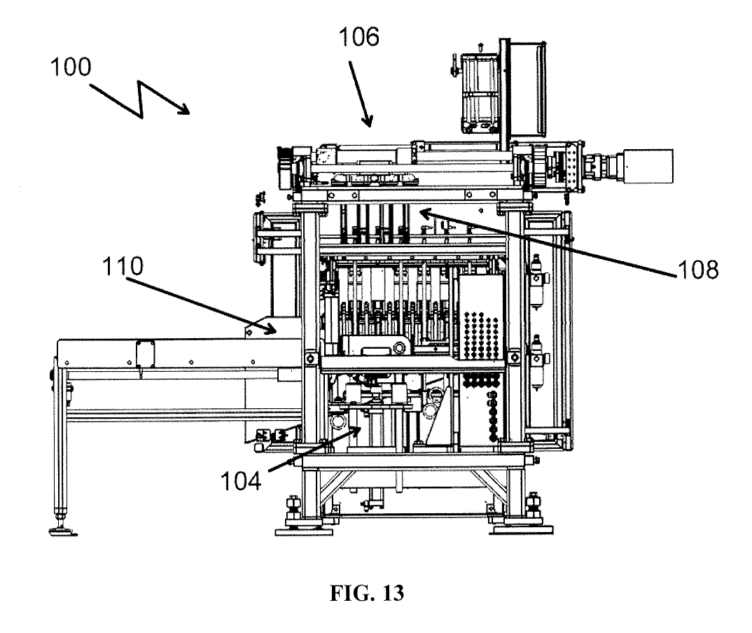

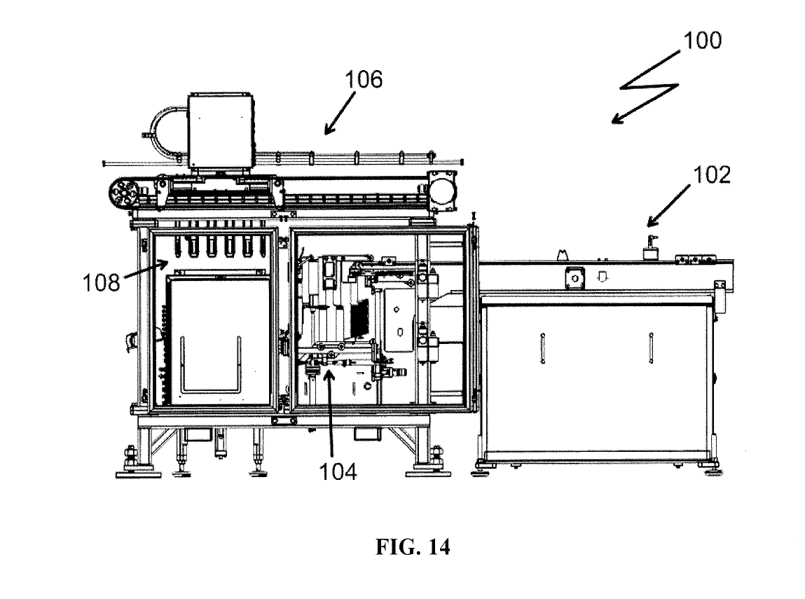

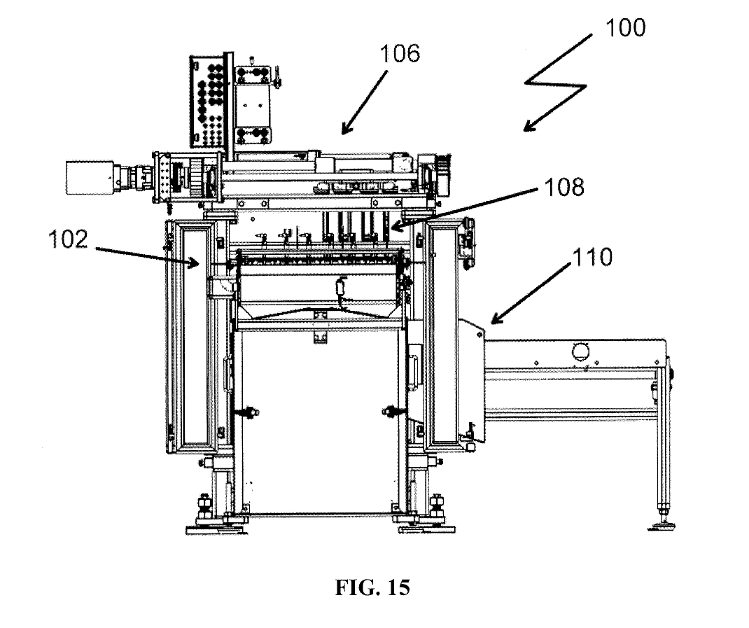

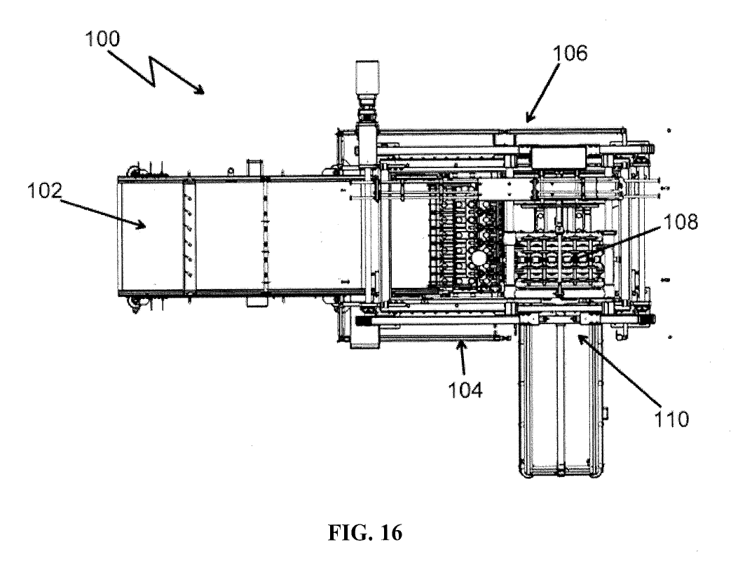

FIG. 11 is a perspective view of system 100 shown in FIG. 10, with certain structures, for example, control panel 112 and support structure 114, removed to facilitate illustration of aspects of the invention. FIG. 12 is a front elevation view of system 100 shown in FIG. 11. FIG. 13 is a right side elevation view, FIG. 14 is a rear elevation view, FIG. 15 is a left side elevation view, and FIG. 16 is a top plan view of system 100 shown in FIG. 11.

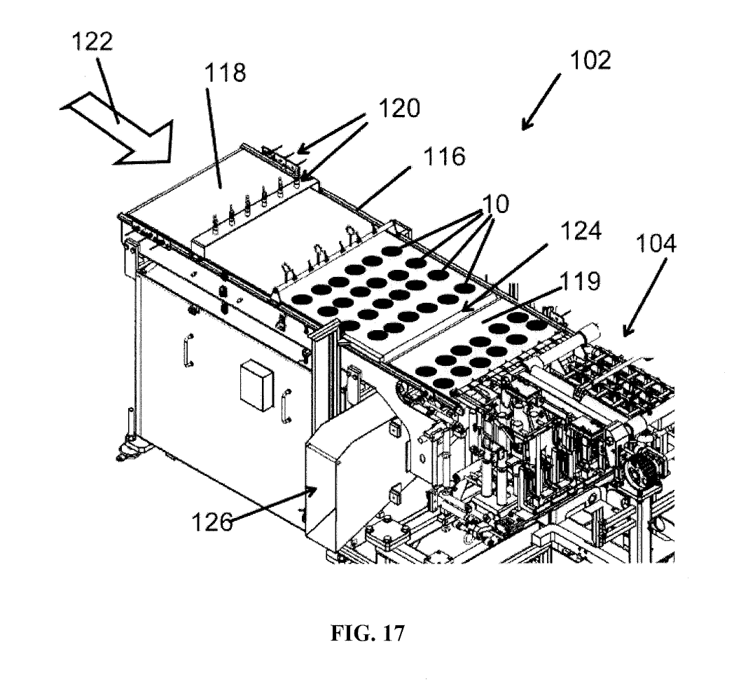

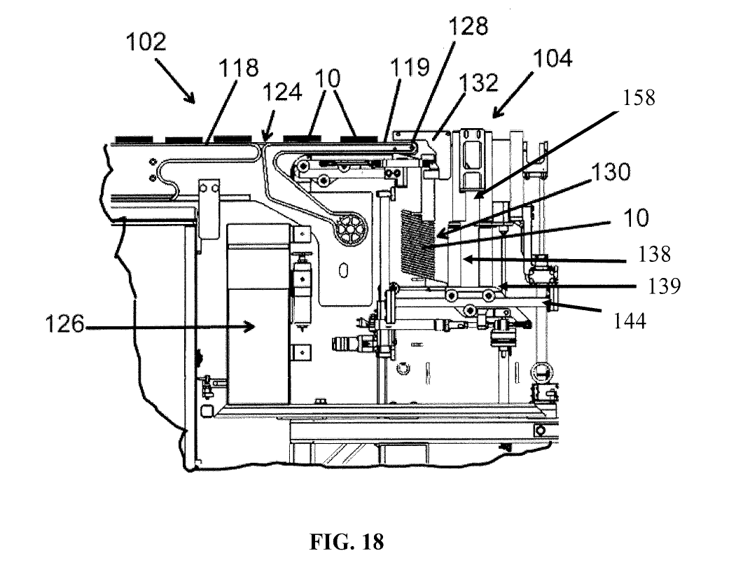

FIG. 17 is a detailed perspective view of conveyor 102 shown in FIG. 11 according to one aspect of the invention and FIG. 18 is a partial side elevation view of conveyor 102 shown in FIG. 17. As shown in FIGS. 17 and 18, conveyor 102 includes a housing 116 and a conveyor belt 118 mounted to housing 116 by conventional means with a conventional conveyor drive and hardware, for example, housing 116 may typically include a conveyor drive mechanism, for instance, drive motors, bearings, belts, pulleys, and gears among other devices. A representative sample of articles 10 are shown on conveyer belt 118. Though six columns of articles 10 are shown on conveyor 102 (for example, N=6), conveyor 102 may convey 2 to even 1000 columns of articles 10, for instance, depending upon the size or articles 10. However, conveyor 102 may typically less then 10 columns or less, for example, from about 2 to about 8 columns of articles 10.

Conveyor 102 may include one or more sensors 120 adapted to detect variations in the size or positioning of articles 10 after articles 10 are loaded on conveyor 102 as indicated schematically by arrow 122 in FIG. 17. In one aspect, should sensors 120 detect articles 10 “out of spec,” for example, too large or too closely packed together on conveyor belt 118, a controller operatively connected to sensors 120 may cause the defective articles to be discharged from conveyor belt 118. For example, in one aspect, conveyor belt 118 may include at least one portion 119 that is movable whereby movement of portion 119 creates an opening 124 in between conveyor belt 118 and belt portion 119 into which the defective articles 10 fall and are collected or conveyed for appropriate handling through discharge bin 126.

If necessary, the invention may also includes one or more devices to ensure that the stackable articles are fed into the apparatus in uniform rows and columns. These devices may include, but are not limited to, lane guides installed parallel to the flow of the stackable articles on the infeed conveyor, drive wheels that insert articles into the lane guides and aid transport of the articles through the lane guides, mechanical fingers or levers that aid the row alignment of articles entering the receiver, or any other such devices that facilitate the alignment of the columns and rows of the stackable articles on the infeed conveyor(s).

As shown most clearly in FIG. 18, articles 10 are discharged from the end 128 of belt 118/119 and accumulate in stacks 130 in receiver and shuttle mechanism 104. Conveyor 102 may include baffles or guide plates 132 positioned to assist in guiding articles 10 off of belt 118/119 and into receiver and shuttle mechanism 104. Stacks 130 may correspond to stacks 20 and 22 shown in FIGS. 1 through 9. Receiver and shuttle mechanism 104 may correspond to location 24 or “first position” (24, 134) and staging position or staging area (64, 104) in FIGS. 1 through 9.

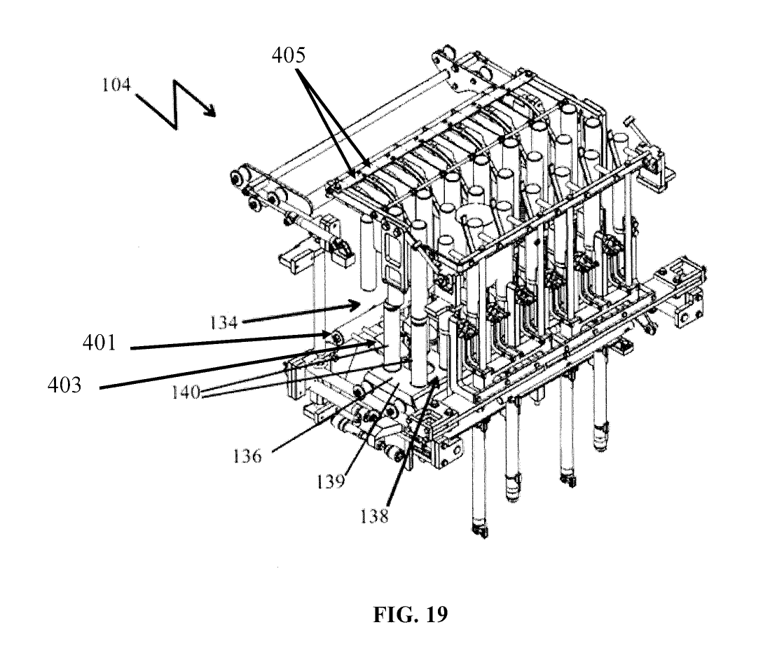

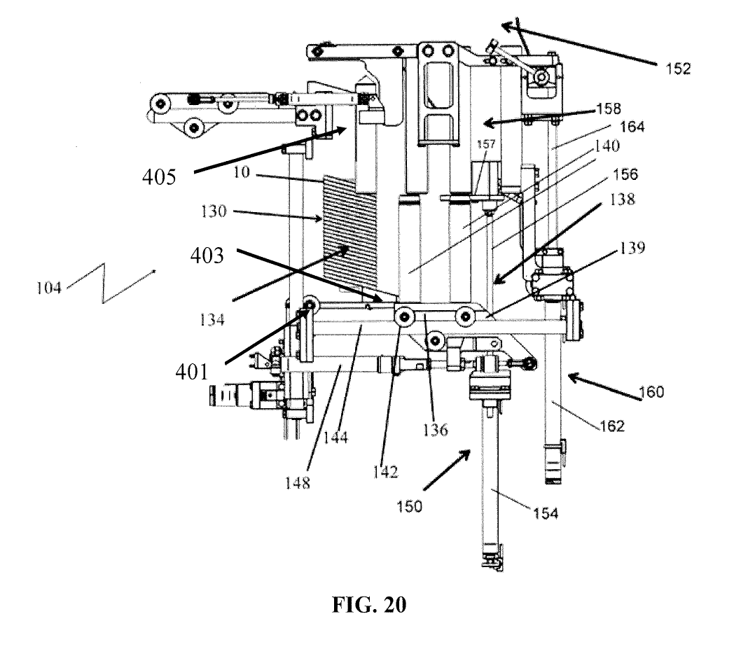

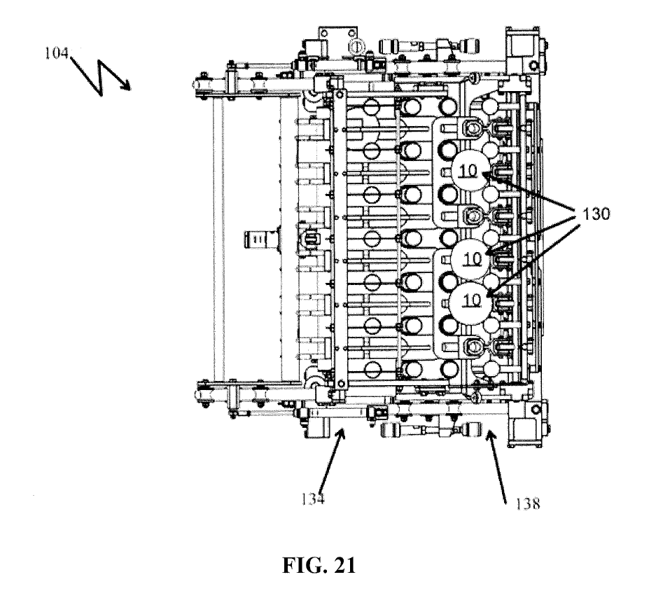

FIG. 19 is a perspective view of a receiver and shuttle mechanism 104 shown in FIGS. 11 through 16. FIG. 20 is a front elevation view of the receiver and shuttle mechanism 104 and FIG. 21 is a top plan view of the receiver and shuttle mechanism 104 shown in FIG. 19. As shown most clearly in FIG. 20, receiver and shuttle mechanism 104 includes a first position 134 positioned and adapted to receive the articles 10 discharged by conveyor 102 in the form of stacks 130 and a shuttle or conveyor 136 positioned and adapted to convey stacks 130 from the first position 134 to a transfer position 138. In one aspect, first position 134 may correspond to location 24 shown in FIGS. 2 through 9.

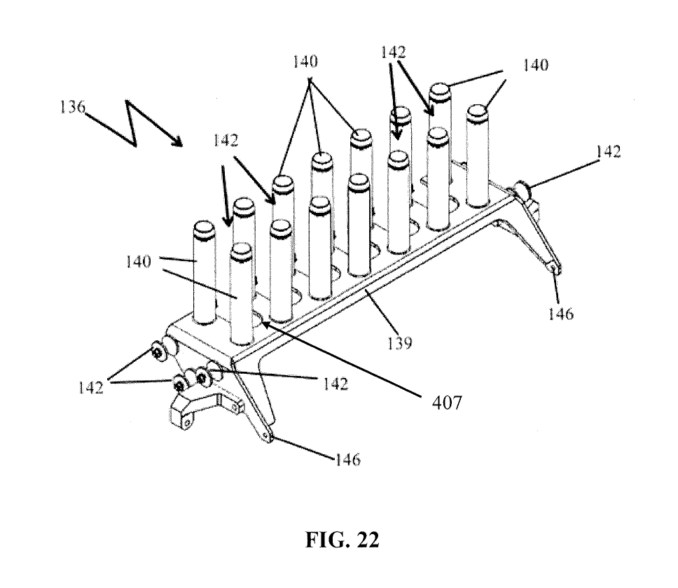

As shown in FIGS. 19-22, according to one aspect of the invention, receiver and shuttle mechanism 104 is adapted to receive articles 104 in the form of stacks 130; for example, N stacks as shown in FIGS. 2-9, and convey stacks 130 to the transfer device 108 (not shown in FIGS. 19-22). Since articles 10 may be continuously discharged into stacks 130, receiver and shuttle mechanism 104 may be adapted to transfer stacks 130 to transfer device 108 without interfering with the receiving of articles 10 in first position 134. In one aspect, this is accomplished with the aid of automated shuttle conveyor 136. A perspective view of one shuttle conveyor 136 that may be used is shown FIG. 22. As shown in FIGS. 20 and 22, shuttle conveyor 136 comprises a base 139 and a plurality of vertical posts 140. The posts 140 are spaced to define openings 142 for receiving articles 10 in the form of stacks 130. Base 139 may typically be equipped with wheels 142 adapted to engage and roll along rails 144 (FIG. 20) whereby shuttle conveyor 136 may translate along rails 144 between position 134 and 138. Base 139 may typically be adapted to engage a means of translating conveyor 136, for example, one or more flanges 146 adapted to engage, for example, a pneumatic cylinder 148 (FIG. 20).

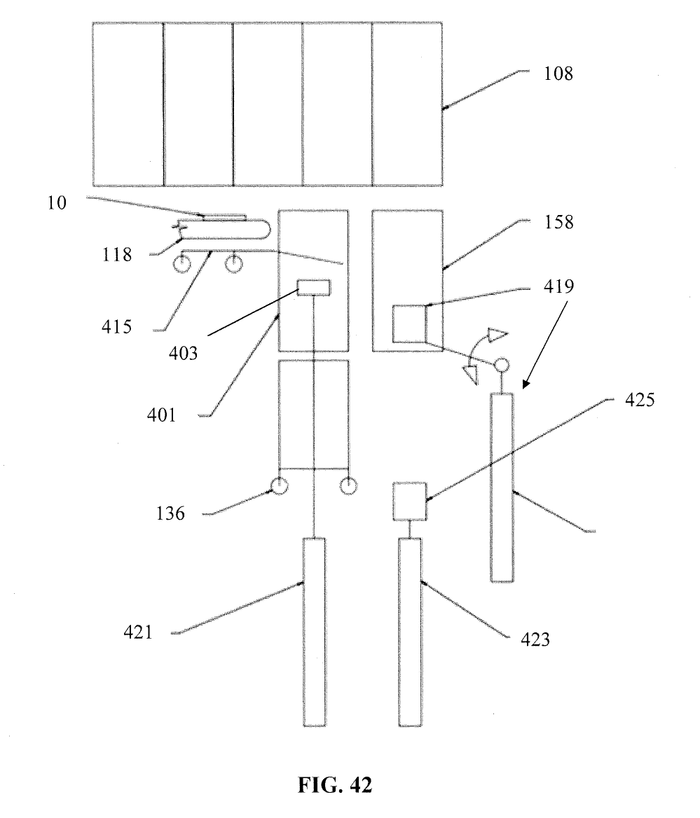

FIG. 42 depicts a schematic representation of components used to transfer stackable articles 10 to transfer device 108. As is shown in FIG. 42, the articles 10 travel along conveyor 118. Located below container 118 is a stop gate 415. Articles 10 on container drop off the edge of conveyor 118 onto the stop gate 415. The stop gate accumulates a set number of articles 10 thereon, for example, 4. When, for example, the four articles 10 are dropped onto the transfer conveyor 118 from a single column on the transfer conveyor the stop gate 415 retracts, typically by translating away from shelf 403 in staging area 158. Since there is a set number of rows articles 10 on the conveyor, for example 6, six stacks of four articles 10 are deposited on the stop gate at a time. Each stack having four articles therein. When the stop gate retracts, each stack falls on a corresponding shelf 403. Each shelf is connected to bar 401 (as shown in FIGS. 18-22). Bar 401 is connected to a lowering mechanism 421 which lowers each shelf 403 and the stacks of articles 10 thereon. Typically, the lower mechanism will receive a set number of stacks of articles 10 each stack having a set number of articles thereon, for example, 25. After the first set of articles 10 is dropped from stop gate 415 onto shelf 403, stop gate 415 translates into its original position to receive additional articles 10 coming off transfer conveyor 118. Lowering mechanism 421 continues to retract until a full stack of articles 10 in each column on each shelf 403 is deposited from the stop gate 415, i.e., 25 articles per stack. The entire stack is lowered into transfer shuttle 136 so that multiple stacks of articles are lowered onto transfer shuttle 136. Transfer shuttle 136 translates approximate staging area 158 and above lifting mechanism 423. The lifting mechanism contains a pocket 425 located below each stack of articles 10 within the transfer shuttle 136. The lifting mechanism 423 lifts one or more pockets 425 to raise the stacks of articles 10 from transfer shuttle 136 into staging area 158. A hinged tool load pusher 419 is located at the bottom of staging area 158 and is pushed by the stacks of articles 10 out of the path of travel of the stacks of article 10 when entering the staging area 158. After the stacks of articles enter staging area 158, the hinged tool load pusher retracts to its original position to support the stacks of articles within the staging area 158. Lifting mechanism 423 may then be used to lift the stacks of articles from staging area into transfer device 108.

As shown most clearly in FIG. 20, receiver and shuttle mechanism 104 is adapted to receive stack 130 while shuttle conveyor 136 is moved into receiver position 134 and, after receiving a predetermined number of stacks 130 (for example, stacks N as shown in FIGS. 2-9) articles 10 (for example, articles M shown in FIGS. 2-9, for instance, M may be 25), the stacks 130 of articles 10 in shuttle conveyor 136 are conveyed from first position 134 to transfer position 138, for example, by means of pneumatic cylinder 148. In the aspect o the invention shown in FIG. 20, shuttle conveyor 136 is portioned between receiver position 134 and transfer position 138. In one aspect, while stacks 130 are being transferred from first position 124 to transfer position 138, articles 10 may continue to be discharged from conveyor 102 to first position 134.

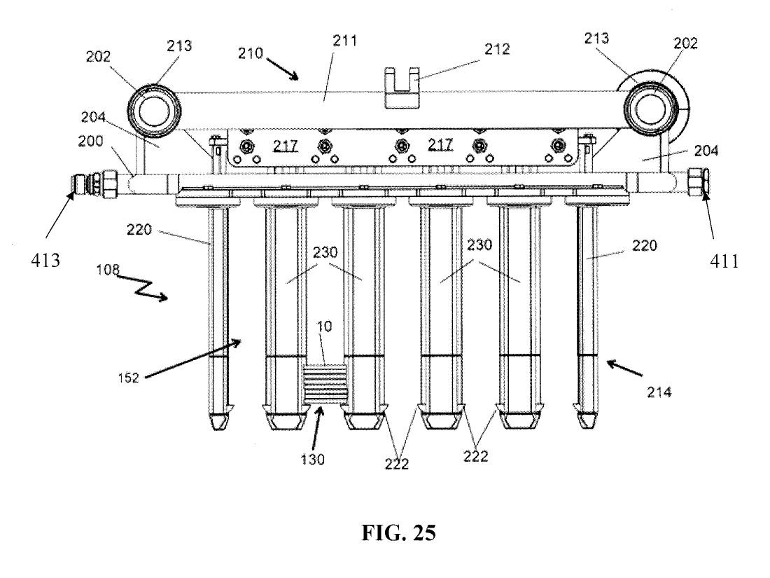

Referring to FIGS. 18-20, the receiver and shuttle mechanism 104 contain a number of compartments 405 corresponding to the number of columns of articles transported on the conveyor. Articles 10 transported by the conveyor will travel into their respective compartments 405. Each compartment may have a moveable stop gate 415 (see FIG. 42) (not shown) upon which the articles may be initially supported. A vertically moveable bar 401 is oriented below the compartments 405. The bar contains a plurality of shelves 403 connected thereto. The bar 401 rises towards the conveyor and compartments 405 and receives the stacked articles from each compartment onto the shelf corresponding to each particular compartment. As the number of articles continues to come off the conveyor, the bar 401 travels vertically lower to allow the size of the stack of articles on each shelf 403 to become larger. When the number of articles on each shelf reaches the preselected amount, as shown in FIG. 20, the bar and shelf are lowered into a position to allow the shuttle conveyor 136 to translate towards the first position 134 below the stacks of articles 130. When the shuttle conveyor 136 is below each of the stacks 130, the bar 401 and shelf 403 lower further to place the stacks of articles on the shuttle conveyor 136. Each shelf 403 is sized to fit within recesses 407 of shuttle 136, as shown in FIG. 22. Thus, the stacks 130 of articles are positioned between vertical post 140 of shuttle conveyor 136. Shuttle conveyor 136 then translates towards transfer position 138 where the lifting mechanism may place each stack 130 into a staging area 158 where the stacks 130 may be vertically inserted into transfer device 108 (shown in FIG. 25). The lifting mechanism may transfer the stacks of articles from transfer position 138 to staging area 158, and even to transfer device, in stages where, for example, half of the total number of stacks 130 of columns in each position is transferred to the next position prior to the remaining half of the stacks being transferred.

According to aspects of the invention, stacks 130 transported to transfer position 138 by shuttle conveyor 136 may be transferred from transfer position 138 to a transfer device, for example, to the transfer device 108 shown in FIGS. 24 through 27. This transfer of stacks 130 from transfer position 138 to a transfer device may be effected by any conventional means. For example, as shown in FIGS. 19-21, the transfer of stacks 130 may be practiced by means of lifting mechanism 150. Lifting mechanism 150 may comprise a translatable housing adapted to lift stacks 130 from transfer position 138 to a position 152 where stacks 130 may be received by a transfer device. As shown in FIG. 20, lifting mechanism 150 may include a pneumatic cylinder 154 having a translating rod 156 mounted to a platform 157 adapted to contact and lift stacks 130 from transfer position 138 to position 152. As disclosed and described with respect to FIGS. 24 through 27, in one aspect, a transfer device is provided to receive stacks 130 in position 152 and transfer the stacks 130, for example, to a container.

In another aspect of the invention, lifting mechanism 150 may be adapted to transfer stacks 130 from transfer position 138 to an intermediate or “staging position” or “buffer position” 158. For example, staging position 158 may be positioned above transfer position 138 so as not to interfere with the movement of shuttle conveyor 136, but lower than position 152 as to not interfere with the motion of a transfer device, such as, transfer device 108 shown in FIGS. 24-27. In one aspect, position 158 may be provided with a retaining device, for example, a retractable shelf, whereby when transfer mechanism 150 raises stacks 130, the retaining device retains the stacks 130 in position 158 after transfer device 150 retracts to transfer position 138. According to one aspect of the invention, another transfer mechanism 160 may be provided to transfer stacks 130 from staging position 158 to position 152 whereby a transfer device may receive the stacks 130. Transfer device 160 may be a lifting mechanism and include a pneumatic cylinder 162 having a translating rod 164 mounted to a platform adapted to contact and lift stacks 130 from staging position 158 to position 152.

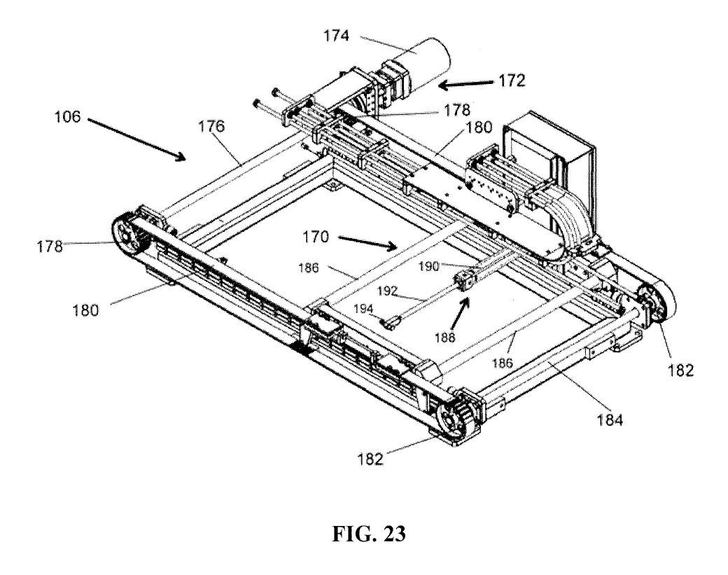

FIG. 23 is perspective view of a conveyor system 106 that may mount above receiver and shuttle mechanism 104 and used to convey the transfer device shown in FIGS. 11 through 16, for example, transfer device 108 shown in FIGS. 24-27. As shown in FIG. 23, conveyor system 106 may comprise a gantry-type conveyor having a translating housing assembly 170 adapted to receive and manipulate a transfer device, such as, transfer device 108 shown in FIGS. 24-27, and a drive mechanism 172 adapted to translate housing assembly 170. As shown in FIG. 23, in one aspect, drive mechanism 172 may include a drive motor 174 adapted to drive a drive shaft 176 operatively connected to a set of driven pulleys 178 sized and position to drive at least one, but as shown, two, belts 180 operatively mounted two driven pulleys 182 mounted to a common shaft 184. In the aspect shown, the belts 180 may comprise toothed, timing-like belts, and the pulleys 178, 182 may comprised complementary toothed, timing-like pulleys. Appropriate bearings, supports, controls, power, and related hardware are provided as is conventional to the proper operation of conveyor system 106.

As is typical, housing assembly 170 is mounted to at least one of belts 180 and translates with belts 180 to translate housing assembly 170 in a horizontal, for example, “x direction.” Housing assembly 170 may include one or more guide rods 186 upon which a transfer device may translate, for example, in a “y direction,” and an actuator 188 adapted to engage and actuate the transfer device as required. For example, as shown in FIG. 22, actuator 188 may include a pneumatic or hydraulic cylinder 190 having a rod 192 and a coupling 194 adapted to engage an appropriate coupling on an actuator on a transfer device, such as, transfer device 108 shown in FIG. 24-37.

Referring to FIGS. 18-22, conveyor 118 operates to transfer articles 10 towards and above first location 134. As articles come off moving conveyor 118 they travel onto a moveable shelf (403). The shelf holds the articles 10 in a stack 30 while moving the stack into a first location. Multiple shelves (403) receive each stack of articles and move together to move all the stacks 130 into first location 134. Thus, stacks 130 are formed side by side, the number of stacks corresponding to the number of columns on conveyor 118. Accordingly, six stacks 130 will be located juxtaposed to one another in first position 134 of the receiver and shuttle mechanism 104. Prior to all stacks 130 being formed in first location 134, shuttle conveyor 136 is moved on rails 144 into a first location 134. Immediately after the top articles 10 in each stack 130 are dropped into their respective locations shuttle conveyor 136 moves along rails 144 to transfer the stacks 130 into transfer position 138. While this is occurring, conveyor 118 continues to operate and drop additional articles 130 into first location 134 to form new stacks 130 of articles in first location 134. After moving stacks 130 into transfer position 138, the shuttle 136 moves back into the first location 134 to receive the new stacks 130. Stacks 130 in transfer position 138 may then be moved into the staging area 158 which is located directly above transfer position 138 via a lifting mechanism 423 (see FIG. 42). A cylinder, such as a pneumatic cylinder (not shown) may be located below one or more stacks 138 and transfer position 138. The one or more pneumatic cylinders may push the stacks 130 from transfer position 138 into staging area 158.

Once in staging area 158, the transfer device 108 may be moved over staging area 158 to receive each stack 130 of articles. The one or more cylinders, for example, may push the stacks from staging area 158 into transfer device 108. Alternatively, for example, the transfer device may contain telescoping cylinders or the like which move into staging area 158 to lift the columns or stacks 130 into the transfer device. Many different mechanisms or techniques may be used for moving the stacks 130 of articles 10 from the transfer position 138 to the staging area 158 and into transfer device 108.

In addition, the stacks 130 of articles 10 located in staging area 158 may be moved into the transfer device 108. For example, when six stacks 130 of articles 10 are located in staging area 158 the cylinders or other means may move, e.g., push the stacks 130 into the transfer in either a single or multiple steps. For example, less than the six stacks 130, for example, three stacks 130 may be moved from transfer position 138 to staging area 158 in a first step, and the remaining three stacks 130 may be moved in a second step, or subsequent steps. For example, typically the transfer device 108 will hold an array of stacks; the number in the array being less than the number of columns of stacks in the staging area. Thus, when six stacks of articles are within the staging area, the transfer device 108 will receive, for example, three stacks in a first step to form three columns in a first row within the transfer device, and then the second three stacks within the staging area are inserted into the transfer device in a second step to form three columns in a second row within the transfer device. This process may continue such that three stacks of columns from each set of columns in the staging area are placed into the transfer device one row at a time, until the transfer device is full of stacks of articles.

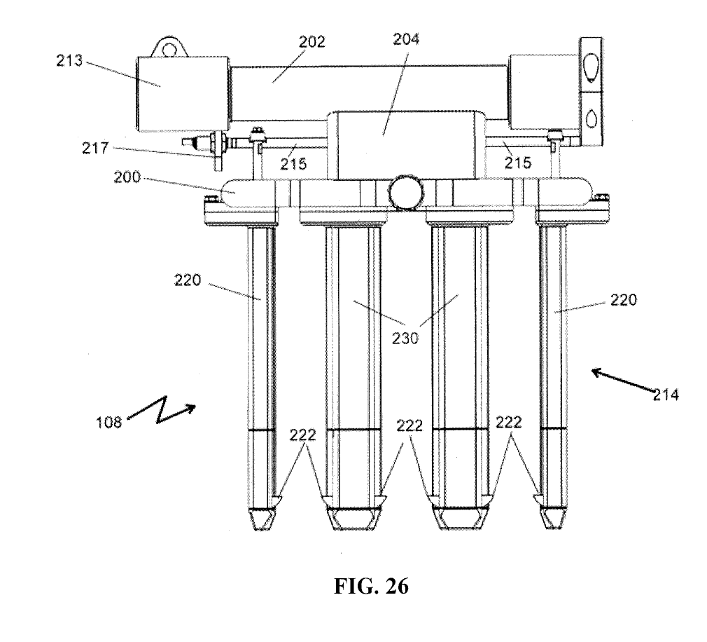

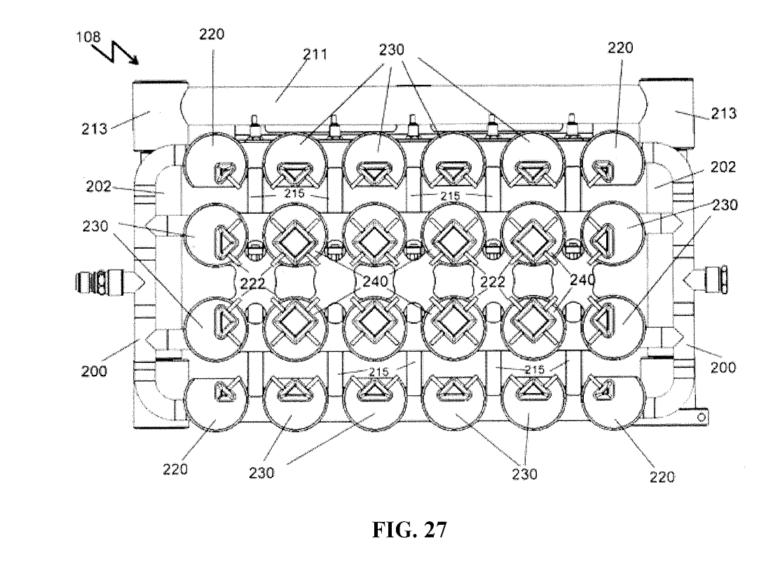

FIG. 24 is a perspective view of a transfer device 108 shown in FIGS. 11 through 16, and which may be translated and actuated by conveyor system 106 shown in FIG. 23. FIG. 25 is a front elevation view of the transfer device 108 shown in FIG. 24, the rear elevation view being a mirror image thereof. FIG. 26 is a right-side elevation view of the transfer device shown 108 in FIG. 24, the left-side elevation view being a mirror image thereof. FIG. 27 is a bottom view of the transfer device 108 shown in FIG. 24.

As shown in FIGS. 24-27, in one aspect of the invention, transfer device 108 may include a support frame 200 and a pair of bearing assemblies 201. Bearing assemblies 201 include at least two, but, as shown, four, guide bearings 213 mounted to guide tubes 202 which are mounted to the support frame by brackets 204. Guide bearings 213 include bearing inserts 207 made of a friction reducing material, such as, PTFE or its equivalent, or may be roller-type anti-friction bearings. Guide tubes 202 and guide bearings 213 are adapted to engage guide rods, for example, guide rods 186 shown in FIG. 23. Transfer device 108 also includes an actuator assembly 210 having an actuator rod or bar 211 that is connected to the bearing assemblies 201 (each having a guide tube 202 and guide bearings 213). Actuator assembly 210 includes a coupling 212 adapted to engage an actuator, for example, actuator 188 shown in FIG. 23, and a plurality of article retaining devices 214. Actuator rod 211 is coupled to a plurality of actuator linkages 215 by means of plate 217 (see FIG. 25). Actuator linkages 215 are adapted to actuate retaining devices 214, for example, by means of camming action or lever action. As will be discussed below, retaining devices 214 may assume several configurations depending upon the location of the retaining devices 214. According to aspects of the invention, retaining devices 214 receive and retain the articles 10 transferred to transfer device 108 by receiver and shuttle mechanism 104.

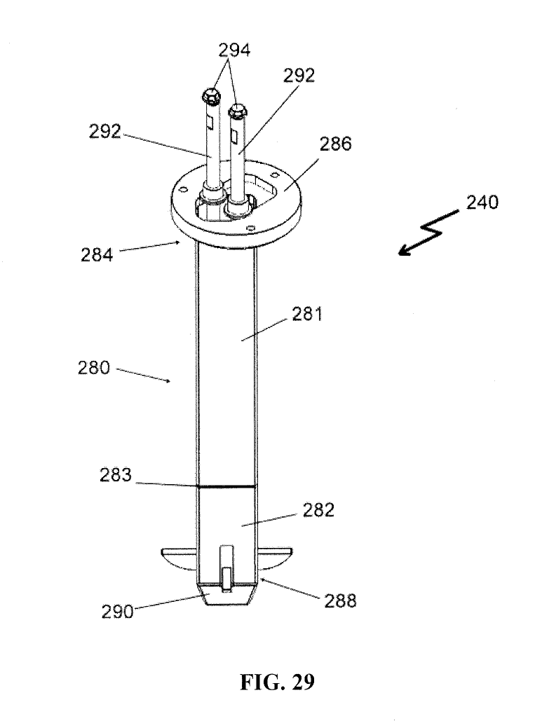

As shown most clearly in FIG. 27, retaining devices 214 may comprise at least three configurations. Retaining device 220 may comprise a single lever arm, bar, or cam 222, and may typically be positioned at a corner of an array or of a set of retaining devices 214 contributing one support lever to two or more support levers 222 supporting one or more articles 10. Retaining device 230 may comprise two support lever arms, bars, or cams 222, and may typically be positioned along a side or edge of set of retaining devices 214 contributing two support lever arms 222 to two or more support lever arms 222 supporting one or more articles 10. Retaining device 240 may comprises four support lever arms, bars, or cams 222, and may typically be positioned within an array or a set of retaining devices 214 contributing four support lever arms 222 to two or more support lever arms supporting an article 10. The details of retaining devices 220, 230, and 240 are similar and are described in detail with respect to retaining device 240 shown in FIGS. 29-33.

According to aspects of the invention, retaining devices 220, 230, and 240 are actuated by means of actuator 210. For example, in one aspect, actuator 210 may be moved by actuator 188 shown in FIG. 24 via the engagement of couplings 194 and 212. Actuator 188 translates rod 211 along rods 202 of housing 200 by means of bearings 213. With the movement of rod 211 and plate 217 mounted to rod 211, rod 211 translates actuator bars 215. The translation of actuator bars 215 actuates retaining devices 220, 230, and 240 to deflect lever arms 222 and retaining one or more articles 10 with retaining devices 220, 230, and 240.

As shown in FIGS. 24-7, the transfer device may be constructed in such a way that it is easy sanitizable. For example, a support frame 200 of the transfer device 108 may be formed as a tube which functions as a manifold. The tube may include an inlet 411 on one end and an outlet 413 on an opposite end. The outlet and inlet may be formed as connections to quickly connect liquid supply hoses thereto. The tube 200 includes a plurality of orifices or spray nozzles therein oriented to direct fluid from within the tube 200 to be discharged therefrom. The nozzles act as jets to allow liquid within the tube 200 to be discharged as a spray from the jets to sanitize the components of the transfer device 108. Pressurized liquid may be injected into the tube 200 via inlet 411. The liquid may comprise water, detergent, other disinfectants and/or other sanitizing fluids.

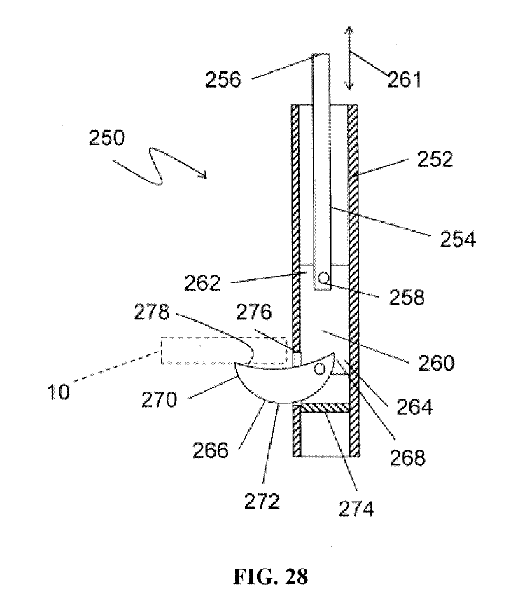

FIG. 28 is a schematic illustration, partially in cross section, of a retaining device 250 according to another aspect of the invention. Device 250 may correspond to one of the retaining devices 220, 230, or 240 shown in FIGS. 24-27. According to one aspect of the invention, the article retaining device 250 includes a transfer guide 252, for example, a tube, a pipe, or a channel, for instance a hollow tube (shown in cross section in FIG. 28), a rod 254 mounted for translation within the transfer guide 252, the rod 254 having a first end 256 operatively connected to a source of motion (not shown), such as, actuator bars 215 shown in FIG. 27, and a second end 258 opposite the first end 256. Retaining device 250 also includes one or more guide sleeves 260 adapted to translate within the transfer guide 252. The guide sleeve 260 typically has a first end 262 mounted to the second end 258 of rod 254, for example, pivotally mounted, and a second end 264 opposite first end 262. In one aspect, the guide sleeve 260 comprises a cylindrical body shaped to conform to a surface of the transfer guide 252. For example, the guide sleeve 260 may comprise a cylindrical body shaped to conform to a plurality of surfaces of the transfer guide 252, for instance, conform to a plurality of inner surfaces of the transfer guide 252. Guide sleeve 260 may comprise a circular cylindrical body or a polygonal cylindrical body, for example, a rectangular cylindrical body or an irregular polygonal cylindrical body.

Though transfer guide 252 is shown as an elongated hollow tube in FIG. 28, transfer guide 252 may be any construction that substantially restricts the movement of guide sleeve 260 to substantially liner motion, such as, vertical motion shown in FIG. 28 by double arrow 261. Accordingly, transfer guide 252 may be a tube, a pipe, a channel, or any other construction that substantially limits the motion of guide sleeve 260. Similarly, guide sleeve 260 may comprise any construction whose motion can be limited by guide 252, including a circular, a cubic, a polyhedral, and a parallelepiped construction, regular or irregular in shape.

The retaining device also includes a lever, rod, or arm 266 having a first end 268 mounted to the second end 264 of the guide sleeve 260, for example, pivotally mounted, and a second end 270. According to one aspect of the invention, the lever 266 includes a camming surface 272 positioned and adapted to contact an obstruction 274 (shown in cross section in FIG. 28) in the transfer guide 252 and urge the second 270 end of the lever 266 through an opening 276 in the transfer guide 252 wherein the second end 270 projects from the transfer guide 252 to provide a retaining surface or point 278 for an article 10 (shown in phantom in FIG. 28).

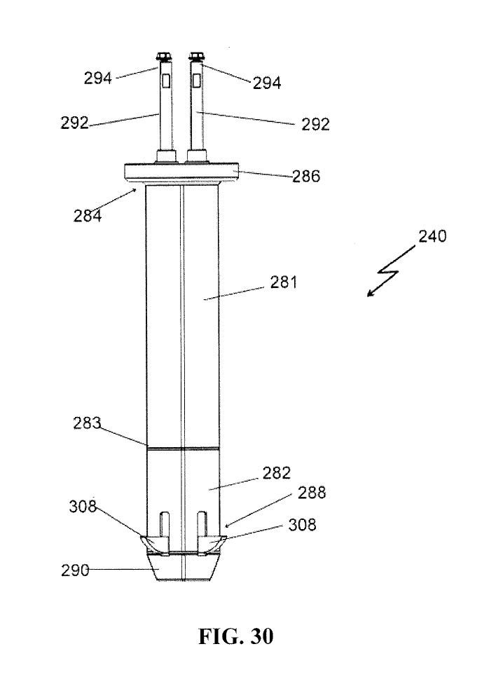

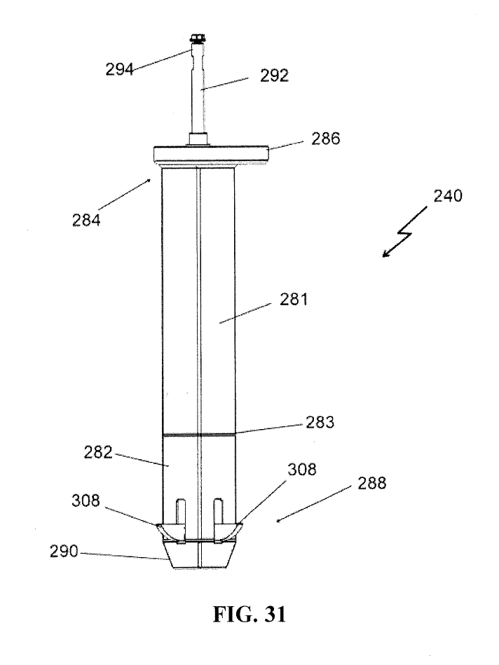

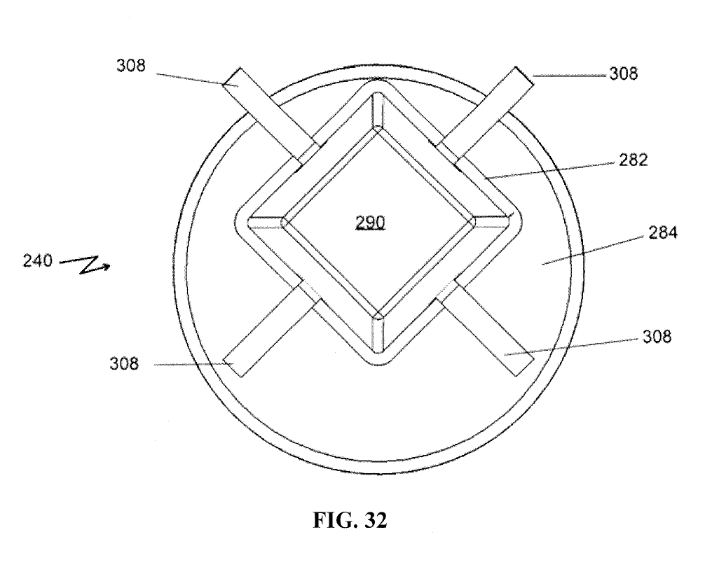

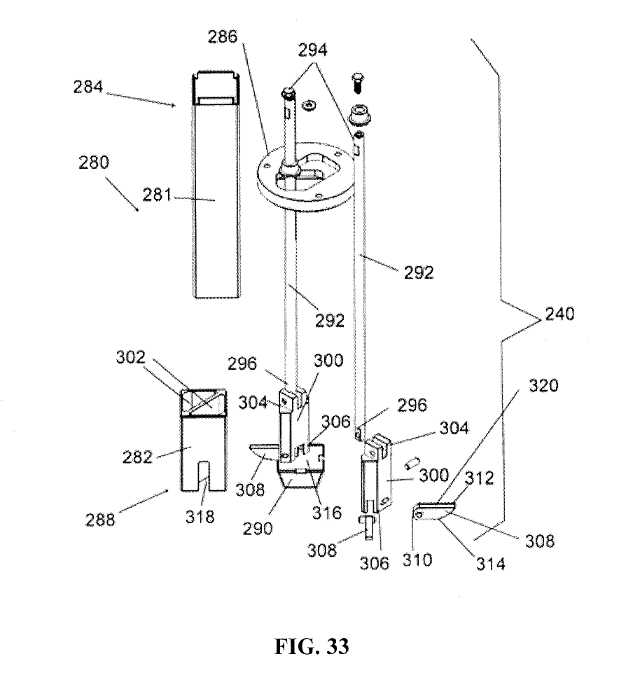

FIG. 29 is a perspective view of one retaining device 240 according to one aspect of the invention shown in FIGS. 24 and 27. FIG. 30 is a front elevation view of retaining device 240 shown in FIG. 29, the rear elevation view being a mirror image thereof. FIG. 31 is a right-side elevation view of retaining device 240 shown in FIG. 29, the left-side elevation view being a mirror image thereof. FIG. 32 is a bottom view of retaining device 240 and FIG. 33 is an exploded perspective view of retaining device 240 shown in FIG. 29. Though different in appearance from retaining devices 220 and 230, the operation and components of retaining device 240 are substantially similar to the operation and components of retaining device 220 and 230.

As shown in FIGS. 29-33, retaining device 240 (and devices 220 and 230) includes an elongated tube 280. In one aspect of the invention, tube 280 may have multiple components, for example, upper tube 281 and lower tube 282. The multiple components may be connected by one or more welds 283. Tube 280 includes a first end 284 mounted to open mounting flange 286 and a second end 288 enclosed by cap 290. In the aspect of the invention shown, the lower tube 282 functions as a guide or channel for retaining device 240. Retaining device 240 includes one or more rods 292, for example, elongated rods, (in this aspect, two elongated rods 292). As described with respect to the aspect shown in FIG. 33, rods 292 are mounted for translation within the hollow tube 280 and have a first end 294 extending through open flange 286 and operatively connected to a source of motion (not shown, such as, actuator bars 215 shown in FIGS. 26 and 27) and a second end 296 opposite the first end 294. Retaining device 240 also includes one or more guide sleeves 300 (two guide sleeves 300 are shown in FIG. 33) adapted to translate within lower tube 282, for example, within two guide channels 302 in lower tube 282. The guide sleeve 300 typically has a first end 304 mounted to the second end 296 of an elongated rod 292, for example, pivotally mounted, and a second end 306 opposite first end 304.

The retaining device 240 (and also devices 220 and 230) includes a lever arm, rod, or bar 308 having a first end 310 mounted to the second end 306 of the guide sleeve 300, for example, pivotally mounted, and a second end 312. According to one aspect of the invention, the lever arm 308 includes a camming surface 314 positioned between first end 310 and second end 312. Camming surface 314 is adapted to contact an obstruction 316 in the channel or hollow tube 282 (for example, the top surface 316 of cap 290) and urge or deflect the second end 312 of the lever 308 through an opening 318 in the tube 282 wherein the second end 312 projects from the tube 282 to provide a retaining surface or point 320 for one or more articles 10, as shown, for example, by the stack 130 of articles 10 in FIG. 25.

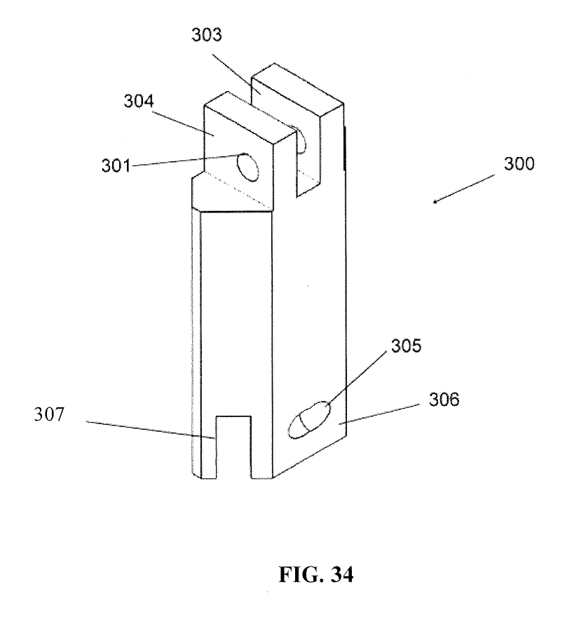

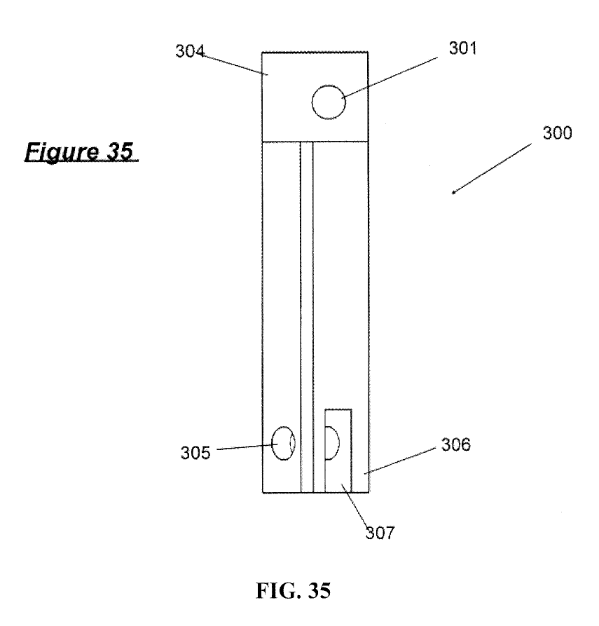

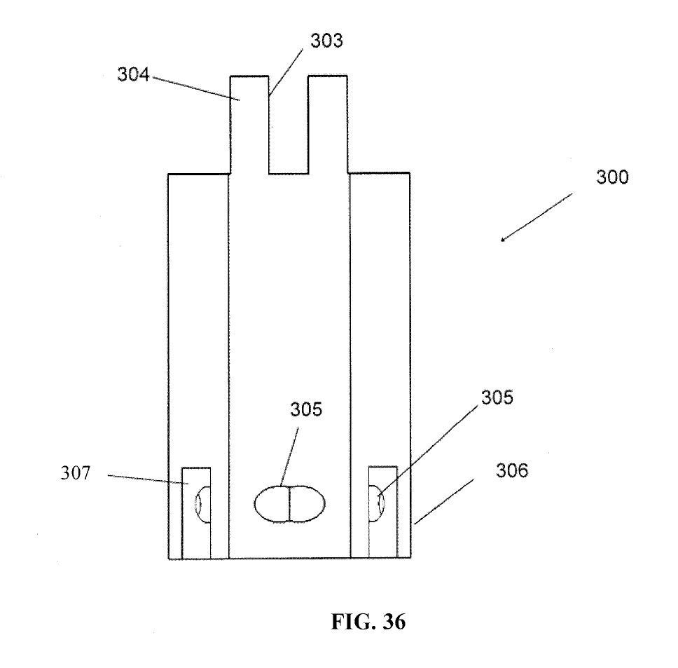

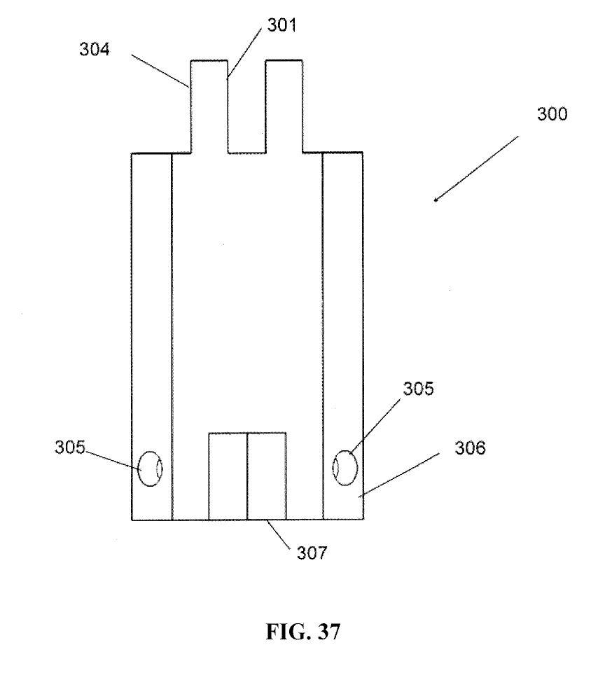

FIG. 34 is a perspective view of the guide sleeve 300 shown in FIG. 33. FIG. 35 is a left-side elevation view of the guide sleeve 300 shown in FIG. 34, the left-side elevation being a mirror image thereof. FIG. 36 is a front elevation view and FIG. 37 is a rear elevation view of guide sleeve 300 shown in FIG. 34. As shown, guide sleeve 300 includes a first end 304 and a second end 306. As shown, guide sleeve 300 may include a through hole 301 and a slot 303 in first end 304 through which hardware can be inserted, for example, a pin, to mount guide sleeve 300 to the second end 296 of rod 292. Guide sleeve 300 may also include a through hole 305 and a slot 307 in second end 306 through which hardware can be inserted, for example, a pin, to mount guide sleeve 300 to the first end 310 of lever arm 308.

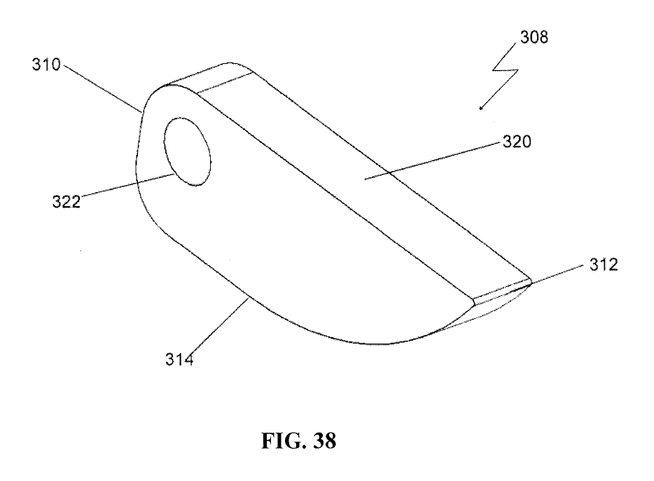

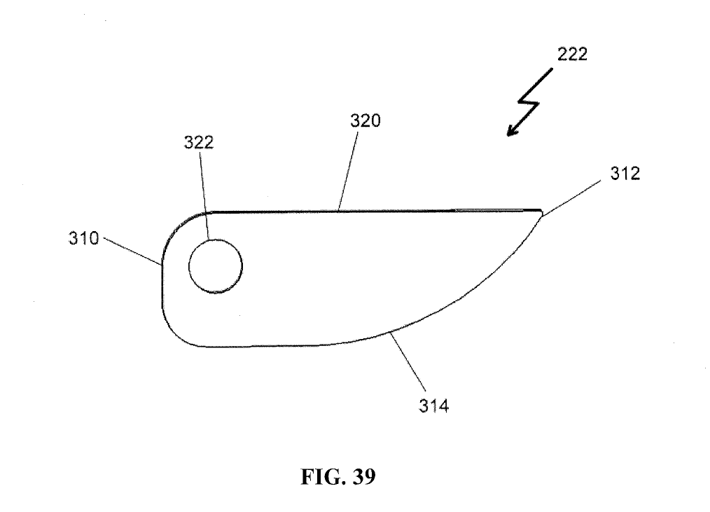

FIG. 38 is a perspective view of the lever arm 308 shown in FIG. 33. FIG. 39 is a right-side elevation view of the lever arm 308 shown in FIG. 38, the left-side elevation view being a mirror image thereof. As shown in FIGS. 38 and 39, lever arm 308 includes a first end 310, second end 312, a camming surface 314, and a retaining surface 320. Lever arm 308 also includes a through hole 322 through which hardware can be inserted, for example, a pin, to mount lever arm 308 to the second end 306 of guide sleeve 300.

In one aspect of the invention, a stacked article retaining system comprising one or more of the retaining devices 220, 230, 240, and/or 250, for example, a plurality of these retaining devices. In another aspect, the system includes one or more of these retaining devices and a source of motion operatively connected to each of the retaining devices adapted to actuate the retaining devices 220, 230, 240, and/or 250. In one aspect, at least 3 retaining devices are provided; in another aspect, at least 4 retaining devices are provided.

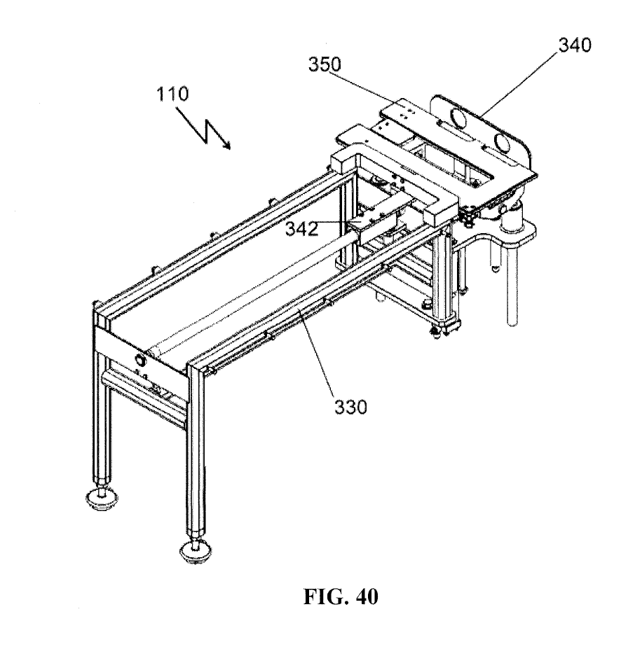

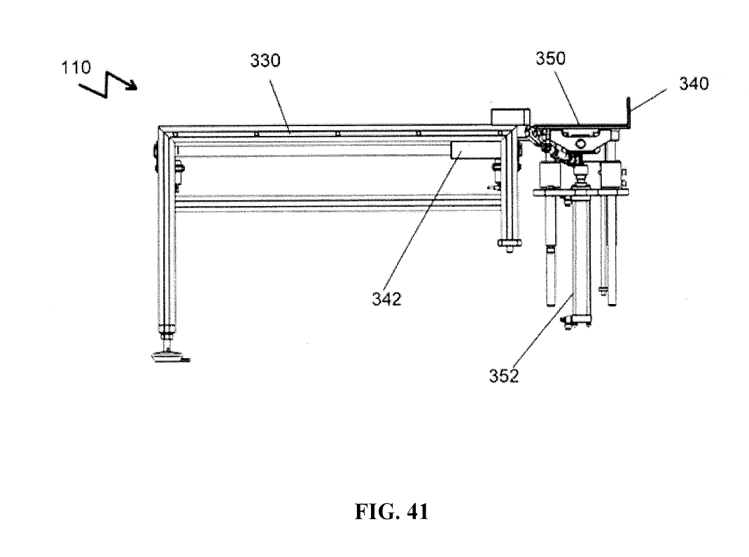

FIG. 40 is a perspective view of the container location 110 shown in FIGS. 10-15. FIG. 41 is a right-side elevation view of the container location 110 shown in FIG. 40. As shown, container location 110 may include a support frame 330 and two platforms: a horizontally translatable platform 340 and a vertically translatable platform 350. A container typically mounted on the surface of platform 350 is not shown in FIGS. 40 and 41. According to aspects of the invention, vertically translatable platform 350 may be adapted to be raised, for example, by means of one or more pneumatic cylinders 352, whereby the container (not shown) placed on platform 350 is raised to a position to receive articles 10 transferred by a transfer device, for example, transfer device 108 shown in FIGS. 24-27. Typically, upon retraction or lowering of platform 350, platform 340 is adapted to translate the container with articles 10 along frame 330 for subsequent handling, for example, storage or shipment. The translation along frame 330 may be effected by one or more pneumatic cylinders 342.

Aspects of the present invention provide devices and methods for transferring articles, for example, food items, such as, frozen hamburger patties. As will be appreciated by those skilled in the art, features, characteristics, and/or advantages of the various aspects described herein, may be applied and/or extended to any embodiment (for example, applied and/or extended to any portion thereof). The device is operable at high speeds and is capable, for example, of stacking goo stackable articles, for example, frozen hamburger patties, or other frozen foods in a container per minute.

Although several aspects of the present invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. A method of processing stackable articles transported in rows on a conveyor, said articles oriented on said conveyor in a set number of columns, comprising:
a) discharging the articles from the conveyor into a receiver to form stacks of said stackable articles in said set number of columns, said stacks having a set number of articles per stack;
b) transferring said set number of columns of stacks of said articles into a transfer device while being able to continue to transport additional rows of stackable articles on said conveyor and discharge the articles into the receiver;
c) repeating steps a) and b) while being able to continue to transport additional rows of stackable materials on said conveyor and discharge the articles into the receiver, to form multiple columns and rows of stacks of said articles within said transfer device;
d) operating said transfer device to transport said multiple rows and columns of said stacks of articles within said transfer device; and
e) discharging said multiple rows and stacks of articles into a container.

2. The method of claim 1 wherein said transferring step comprises moving said set number of columns of stacks of said articles from a first position to a staging area, wherein said set number of columns of stacks of said articles are inserted into said transfer device from said staging area.

3. The method of claim 2 wherein moving said set number of columns of stacks of said articles from a first position to a staging area comprises translating said stacks of said articles from said first position to said staging area, said staging area located in alignment with said transfer device when said set number of columns of said stack of said articles are transferred into said transfer device.

4. The method of claim 3 wherein said set number of columns of stacks of articles are vertically inserted into receiving columns of said transfer device.

5. The method of claim 4 wherein said set number of columns of stacks of articles are moved from said first position to a transfer position, and from said transfer position to said staging area.

6. The method of claim 5 wherein said set number of columns of stacks of articles are vertically inserted into said receiving columns of said transfer devices by moving less than said set number of columns of said stacks of articles from said staging area in a first step and vertically inserting the remainder of said set number of columns of stacks of articles from said staging area in one or more subsequent steps.

7. The method of claim 6 wherein said transfer device receives an array of stacks of articles said array comprising a number of columns less than the set number of columns and a set number of rows of stack of articles, wherein said array of stacks is used to fit into said container.

8. The method of claim 7 wherein said transfer device is moveable in a horizontal plane in two dimensions to position said receiving columns in vertical alignment with said stacks of articles in said staging area.

9. The method of claim 6 wherein said transfer device is moveable to receive said less than said set number of columns of said stacks from said staging area in a first step within a first row of said transfer device, and moveable to receive said remainder of said set number of columns of stacks of articles in one or more subsequent steps from said staging area in at least a second row of said transfer device.

10. The method of claim 9 wherein said container is positioned on a platform, said platform being vertically moveable towards said transfer device to place said container proximate said transfer device wherein said transfer device releases said multiple rows of stacks of articles into said container and said stacks of articles are vertically discharged into said container.

11. An apparatus for processing stackable articles transported in rows on a conveyor, said articles oriented in a set number of columns, comprising:
a receiver positioned to receive articles discharged from a conveyor to form stacks of said stackable articles in said set number of columns, said stacks having a set number of articles per stack;
a transfer device positionable with respect to said receiver to transfer said set number of columns of stacks of said articles while being able to continue to transport additional rows of stackable articles on said conveyor and discharge the articles into the receiver to form multiple columns and rows of stacks of articles within said transfer device;
said transfer device being operable to transport said multiple rows and columns of said stacks of articles within said transfer device; and
a container support positionable to support a container proximate said transfer device wherein said transfer device discharges said multiple rows and stacks of articles into said container.

12. The apparatus of claim 11 wherein said receiver comprises a staging area positioned to allow said set number of columns of stacks of said articles received from a first position to be inserted into said transfer device from said staging area.

13. The apparatus of claim 12 wherein said staging is located in alignment with said transfer device when said set number of columns of said stack of said articles are transferred into said transfer device.

14. The apparatus of claim 13 wherein said transfer device comprises an array of receiving columns positionable to receive said set number of columns of stacks of articles vertically inserted into said receiving columns.

15. The apparatus of claim 14 wherein said receiver moves said set number of columns of stacks of articles from said first position to a transfer position, and from said transfer position to said staging area.

16. The apparatus of claim 15 wherein said transfer device is moveable to receive said less than said set number of columns of said stacks of articles from said staging area in a first step and the remainder of said set number of columns of stacks of articles from said staging area in one or more subsequent steps.

17. The apparatus of claim 16 wherein said transfer device is configured to receives an array of stacks of articles, said array comprising a number of columns less than the set number of columns and a set number of rows of stack of articles, wherein said array of stacks fits into said container.

18. The apparatus of claim 17 wherein said transfer device is moveable in a horizontal plane in two dimensions to position said receiving columns in vertical alignment with said stacks of articles in said staging area.

19. The apparatus of claim 16 wherein said transfer device is moveable to receive said less than said set number of columns of said stacks from said staging area in a first step within a first row of said transfer device, and moveable to receive said remainder of said set number of columns of stacks of articles in one or more subsequent steps from said staging area in at least a second row of said transfer device.

20. The apparatus of claim 19 wherein said container support is vertically moveable towards said transfer device to place said container proximate said transfer device wherein said transfer device releases said multiple rows of stacks of articles into said container and said stacks of articles are vertically discharged into said container.

21. An article retaining device comprising:
a transfer guide;
one or more rods mounted for translation within the transfer guide, the one or more rods each having a first end operatively connected to a source of motion and a second end opposite the first end;
one or more guide sleeves adapted to translate within the transfer guide, the one or more guide sleeves having a first end mounted to the second end of one of the one or more rods and a second end opposite the first end; and
a lever arm having a first end pivotally mounted to the second end of one of the one or more guide sleeves and a second end, the lever arm having a camming surface positioned and adapted to contact an obstruction in the transfer guide and urge the second end of the lever arm through an opening in the transfer guide wherein the second end projects from the transfer guide to provide a retaining surface.

22. The device as recited in claim 21, wherein the transfer guide comprises one of a channel, a tube, and a pipe.

23. The device as recited in claim 21 wherein the one or more rods comprise one or more elongated rods.

24. The device as recited in claim 21 wherein the lever arm comprises a plurality of lever arms.

25. The device as recited in claim 21 wherein the obstruction in the transfer guide comprises a surface of a cap on the transfer guide.

26. The device as recited in claim 21 wherein the one or more guide sleeves comprise a cylindrical body shaped to conform to a surface of the transfer guide.

27. The device as recited in claim 26, wherein the one or more guide sleeves comprise a cylindrical body shaped to conform to a plurality of surfaces of the transfer guide.

28. The device as recited in claim 27, wherein the one or more guide sleeves comprise a cylindrical body shaped to conform to a plurality of inner surfaces of the transfer guide.

29. The device as recited in claim 21 wherein the device comprises one or more guide sleeves comprise a device for retaining stackable articles.

30. The device as recited in claim 29, wherein the stackable articles comprise frozen hamburger patties.

31. A stacked article retaining system comprising:
a plurality of retaining devices as recited in claim 21; and
a source of motion operatively connected to each of the first end of each of the elongated rods of the plurality of retaining devices.

32. The stacked article retaining system as recited in claim 31, wherein the plurality of retaining devices comprises at least 3 retaining devices.

33. The stacked article retaining system as recited in claim 31, wherein the at least 3 retaining devices comprises 4 retaining devices.
